(19) United States
(12) Patent Application Publication
(10) Pub. No.: US 2026/0152373 A1
(43) Pub. Date: Jun. 4, 2026

(54) CRANE

(71) Applicant: KOBELCO CONSTRUCTION MACHINERY CO., LTD., Hiroshima-shi (JP)

(72) Inventors: Koji SUMIMOTO, Hyogo (JP); Teppei MAEDO, Hyogo (JP)

(73) Assignee: KOBELCO CONSTRUCTION MACHINERY CO., LTD., Hiroshima-shi (JP)

(21) Appl. No.: 18/703,986

(22) PCT Filed: Oct. 19, 2022
(86) PCT No.: PCT/JP2022/038921

§ 371 Date: Apr. 23, 2024

(30) Foreign Application Priority Data
Oct. 27, 2021 (JP) 2021-175489
Oct. 27, 2021 (JP) 2021-175490

(51) Int. Cl. B66C 23/82; B66C 23/36

(52) U.S. Cl. CPC B66C 23/823; B66C 23/36; B66C 2700/0371

(57) ABSTRACT

A crane includes a strut guyline stretched between a lying lower portion, which is a portion located at a lower portion of a boom in a state where the boom and a jib are arranged in a lying attitude, and a strut, the strut guyline including a boom-side connection portion that is an end portion connected to the lying lower portion of the boom, in which a plurality of connectors includes a specific connector that is a connector arranged at a position corresponding to the lying lower portion, the plurality of coupling pins includes a specific coupling pin used in the specific connector, and the specific coupling pin or the specific connector includes a guyline attachment portion which is a portion to which the boom-side connection portion of the strut guyline is detachably attached.

### TECHNICAL FIELD

The present disclosure relates to a crane.

### BACKGROUND ART

Patent Literature 1 discloses a crane including a lower travelling body, an upper slewing body slewably supported on the lower travelling body, a boom supported on the upper slewing body in a raisable and lowerable manner, a jib supported on a distal end portion of the boom, a strut, and a strut guyline stretched between the strut and the boom. In the conventional crane as disclosed in Patent Literature 1, a connection link which is one end portion of the strut guyline and is connected to the boom is connected to a portion located on an upper portion of the boom (hereinafter, this portion is referred to as a lying upper portion) in a state where the boom and the jib are arranged in a lying attitude.

When the crane is transported, the crane is disassembled into a plurality of parts and assembled at a destination which is a transportation destination. The assembling work of the crane includes a strut guyline connecting work which is a work of connecting a strut guyline to a boom. The disassembly work of the crane includes a strut guyline removal work which is a work of removing the strut guyline from the boom. Each of the strut guyline connecting work and the strut guyline removal work is performed in a state where the boom and the jib are arranged in the lying attitude.

In the strut guyline connecting work and the strut guyline removal work, a worker needs to ascend to the lying upper portion of the boom and descend from the lying upper portion of the boom while the boom and the jib are arranged in the lying attitude. Thus, these operations take time. Further, the connection link of the strut guyline is a heavy object, and thus it takes a long time to move the connection link to a high position corresponding to the lying upper portion of the boom using an auxiliary crane.

### CITATION LIST

### Patent Literature

Patent Literature 1: JP 2019-099352 A

### SUMMARY OF INVENTION

The present disclosure has been made in view of the above problems, and an object of the present disclosure is to provide a crane capable of improving workability of a strut guyline connecting work and a strut guyline removal work.

A crane to be provided includes a machine body, a boom supported on the machine body in a raisable and lowerable manner, the boom including a first boom member and a second boom member arranged in a line in a longitudinal direction of the boom, a plurality of connectors coupling the first boom member and the second boom member, and a plurality of coupling pins respectively inserted into pin holes of the plurality of connectors, a jib that is supported by the boom and includes a proximal end portion attached to a distal end portion of the boom, a strut supported by the distal end portion of the boom or the proximal end portion of the jib, and a strut guyline that is a guyline stretched between a lying lower portion, which is a portion located at a lower portion of the boom in a state where the boom and the jib are arranged in a lying attitude, and the strut, the strut guyline including a boom-side connection portion that is an end portion connected to the lying lower portion of the boom, in which the plurality of connectors includes a specific connector that is a connector arranged at a position corresponding to the lying lower portion, the plurality of coupling pins includes a specific coupling pin used in the specific connector, and the specific coupling pin or the specific connector includes a guyline attachment portion which is a portion to which the boom-side connection portion of the strut guyline is detachably attached.

### BRIEF DESCRIPTION OF DRAWINGS

FIG. 1 is a side view illustrating a crane according to an embodiment of the present disclosure.

FIG. 2 is a perspective view illustrating a boom, a jib, a strut, and a strut guyline in the crane.

FIG. 3 is a view of the boom, the jib, the strut, and the strut guyline in the crane as viewed from above.

FIG. 4 is a view illustrating a connection structure for connecting an end portion of the strut guyline to the boom in the crane according to the first embodiment of the present disclosure, and is a view of the connection structure as viewed from above.

FIG. 5 is a side view of the connection structure.

FIG. 6 is a plan view illustrating two types of coupling pins.

FIG. 7 is a perspective view illustrating the connection structure for connecting an end portion of a strut guyline to a boom in a crane according to a modification of the first embodiment, and is a view of the connection structure as viewed obliquely from above.

FIG. 8 is a view of the connection structure in the crane according to the modification as viewed obliquely from below.

FIG. 9 is a cross-sectional view of the connection structure in the crane according to the modification.

FIG. 10 is a perspective view illustrating a coupling pin used for the connection structure in the crane according to the modification.

FIG. 11 is a perspective view illustrating a specific connector that connects boom members of the boom and couples an end portion of a strut guyline to the boom in a crane according to a second embodiment of the present disclosure.

FIG. 12 is a perspective view illustrating a third connector part of the specific connector. FIG. 13 is a cross-sectional view illustrating the specific connector.

FIG. 14 is a perspective view illustrating a third connector part of the specific connector in a crane according to Modification 1 of the second embodiment.

FIG. 15 is a perspective view illustrating a specific connector in a crane according to Modification 2 of the second embodiment.

FIG. 16 is a perspective view illustrating a specific connector in a crane according to Modification 3 of the second embodiment.

### DESCRIPTION OF EMBODIMENTS

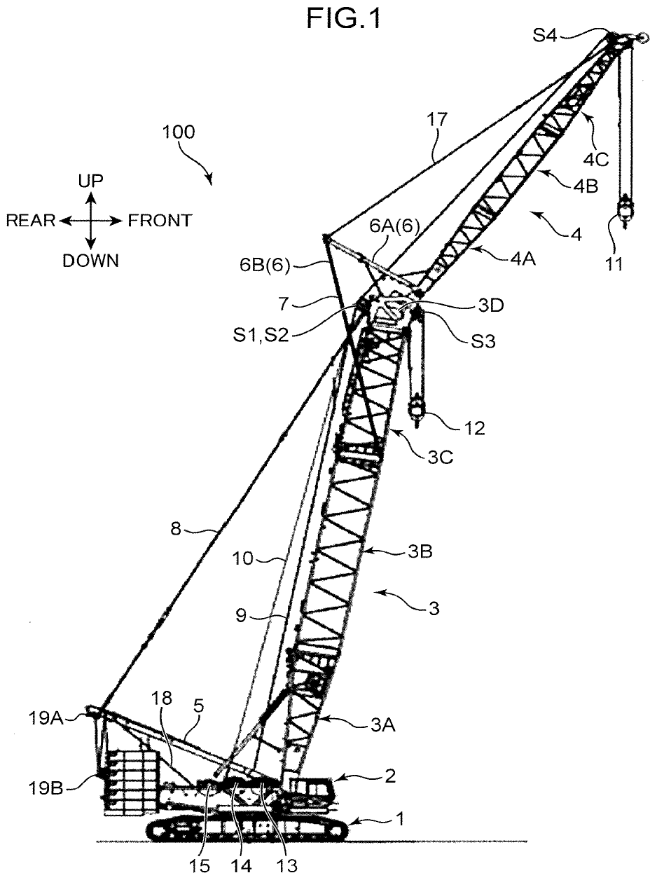

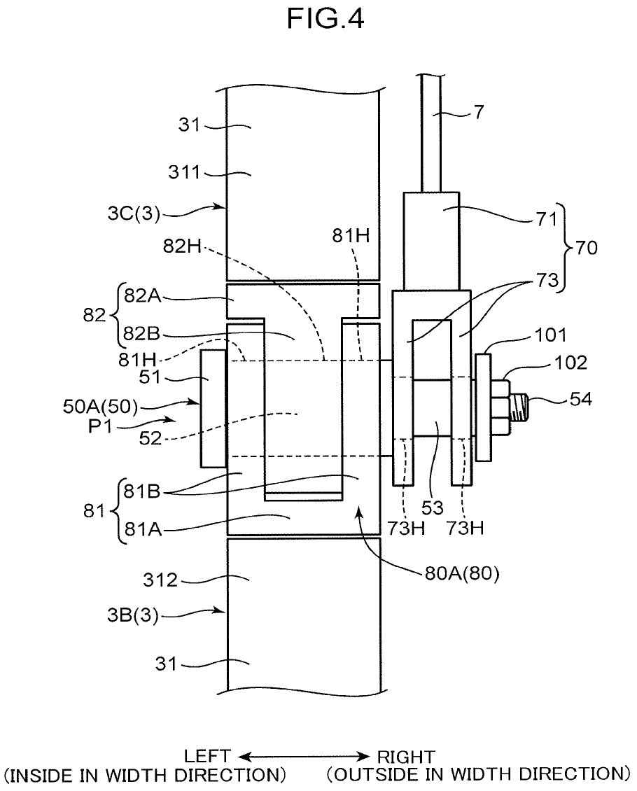

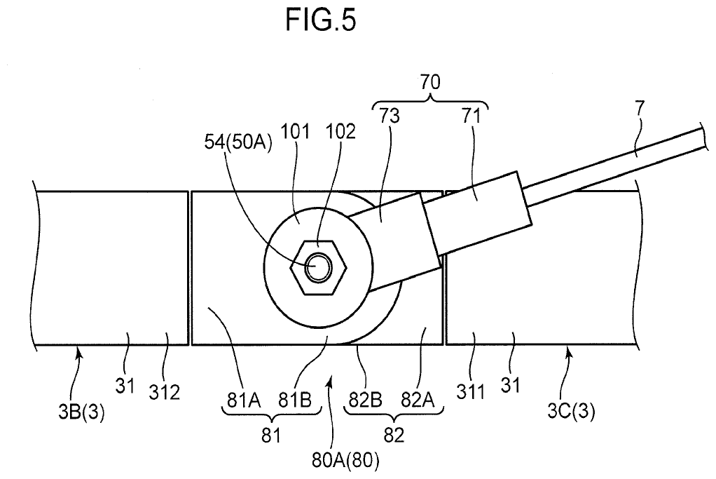

Hereinafter, a crane according to a first embodiment and a crane according to a second embodiment of the present disclosure will be described with reference to the drawings. FIGS. 1 to 3 are common to the first embodiment and the second embodiment. FIGS. 4 to 10 relate to the first embodiment, and FIGS. 11 to 16 relate to the second embodiment.

As illustrated in FIGS. 1 to 3, a crane 100 includes a lower travelling body 1 capable of self-travelling, an upper slewing body 2 mounted on the lower travelling body 1 so as to be slewable about an axis in an up-down direction with respect to the lower travelling body 1, and a raising/lowering member supported on the upper slewing body 2 so as to be raisable and lowerable with respect to the upper slewing body 2. The raising/lowering member includes a boom 3 and a jib 4. The lower travelling body 1 includes a pair of crawler travelling devices and a lower frame supported by these travelling devices. The upper slewing body 2 includes an upper frame slewably supported on the lower frame, a cabin supported to a front portion of the upper frame, and a counterweight supported on a rear portion of the upper frame. The lower travelling body 1 and the upper slewing body 2 are examples of a machine body. The crane 100 according to the present embodiment is what is called a fixed jib specification crane. In the fixed jib specification, the jib 4 is attached to the boom 3 in a state where the angle of the jib 4 with respect to the boom 3 is fixed. Note that “front”, “rear”, “right”, and “left” in the drawings are based on the orientation of the upper slewing body 2.

The boom 3 includes a boom proximal end portion (boom foot) which is a proximal end portion supported by the upper slewing body 2 so as to be rotatable about a rotation center axis extending in a left-right direction, and a boom distal end portion which is a distal end portion located on the side opposite to the boom proximal end portion in a longitudinal direction of the boom 3. The boom 3 includes a plurality of boom members. The boom 3 has a structure in which a plurality of boom members is arranged and coupled in a line in the longitudinal direction of the boom 3.

Specifically, in the present embodiment, the plurality of boom members includes a lower boom member 3A including the boom proximal end portion, a plurality of intermediate boom members 3B and 3C, and an upper boom member 3D including the boom distal end portion. The lower boom member 3A, the intermediate boom member 3B, the intermediate boom member 3C, and the upper boom member 3D are arranged in this order in the longitudinal direction of the boom 3. The intermediate boom member 3C has a tapered shape in which the dimension in the width direction decreases toward the boom distal end portion of the boom 3. Guide sheaves S1 and S2 and a boom point sheave S3 are rotatably attached to the upper boom member 3D. The plurality of boom members may not necessarily include the plurality of intermediate boom members. In addition, the number of intermediate boom members may be one, or the intermediate boom members may be omitted. The intermediate boom member 3B is an example of a first boom member, and the intermediate boom member 3C is an example of a second boom member.

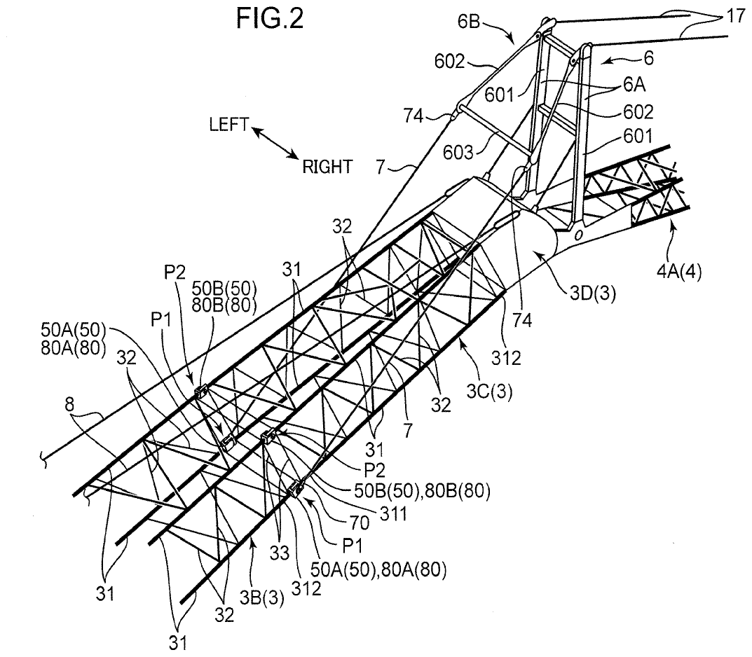

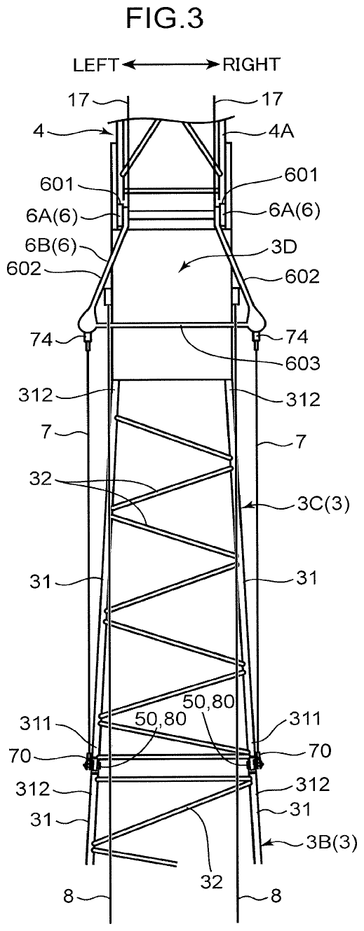

The boom 3 is what is called a lattice type boom, and at least one of the plurality of boom members is what is called a lattice type structure. Specifically, as illustrated in FIGS. 2 and 3, for example, each of the intermediate boom members 3B and 3C includes four main pipes 31, a plurality of inclined pipes 32, and a plurality of lateral pipes 33.

In each of the intermediate boom members 3B and 3C, the four main pipes 31 are arranged at positions corresponding to four vertexes of a rectangle in a cross section of the intermediate boom member cut along a plane perpendicular to a longitudinal direction of the intermediate boom member. Each of the four main pipes 31 is arranged in an attitude extending in a direction along the longitudinal direction of the intermediate boom member. Each of the four main pipes 31 includes a main pipe proximal end portion 311 which is a proximal end portion in the longitudinal direction thereof and a main pipe distal end portion 312 which is a distal end portion in the longitudinal direction thereof. In each intermediate boom member, the main pipe proximal end portion 311 is an end portion arranged at a position closer to the boom proximal end portion than the main pipe distal end portion 312.

In each of the intermediate boom members 3B and 3C, each of the plurality of inclined pipes 32 is arranged so as to connect two adjacent main pipes 31 among the four main pipes 31. The plurality of inclined pipes 32 is arranged continuously in a zigzag manner between the two main pipes 31. Each of the plurality of inclined pipes 32 is arranged in an attitude inclined with respect to the longitudinal direction of the intermediate boom member.

In the intermediate boom member 3B, each of the plurality of lateral pipes 33 is arranged so as to connect the main pipe distal end portions 312 of two adjacent main pipes 31 among the four main pipes 31. In the intermediate boom member 3B, each of the plurality of lateral pipes 33 is arranged in an attitude orthogonal to the longitudinal direction of the intermediate boom member 3B.

In the intermediate boom member 3C, each of the plurality of lateral pipes 33 is arranged so as to connect the main pipe proximal end portions 311 of two adjacent main pipes 31 among the four main pipes 31. In the intermediate boom member 3C, each of the plurality of lateral pipes 33 is arranged in an attitude orthogonal to the longitudinal direction of the intermediate boom member 3C.

The boom 3 further includes four connectors 80 for coupling the intermediate boom member 3B and the intermediate boom member 3C. The four connectors 80 couple the four main pipes 31 of the intermediate boom member 3B and the four main pipes 31 of the intermediate boom member 3C. As illustrated in FIGS. 4 and 5, each of the four connectors 80 includes a first connector part 81 and a second connector part 82. The first connector part 81 is attached to the main pipe distal end portion 312 of the main pipe 31 of the intermediate boom member 3B, and the second connector part 82 is attached to the main pipe proximal end portion 311 of the main pipe 31 of the intermediate boom member 3C.

One of the first connector part 81 and the second connector part 82 is a male connector part having a male shape, and the other of the first connector part 81 and the second connector part 82 is a female connector part having a female shape. In the present embodiment, the first connector part 81 is the female connector part and the second connector part 82 is the male connector part, but these may have opposite shapes.

The first connector part 81 includes an attachment portion 81A which is a portion attached to the main pipe distal end portion 312 of the main pipe 31 of the intermediate boom member 3B, and a pair of plate-shaped protrusions 81B protruding from the attachment portion 81A in the longitudinal direction of the main pipe 31. The pair of protrusions 81B is arranged with an interval in the left-right direction.

The second connector part 82 includes an attachment portion 82A which is a portion attached to the main pipe proximal end portion 311 of the main pipe 31 of the intermediate boom member 3C, and a plate-shaped protrusion 82B protruding from the attachment portion 82A in the longitudinal direction of the main pipe 31. The thickness of the protrusion 82B is slightly smaller than the interval between the pair of protrusions 81B. Thus, the protrusion 82B can be arranged between the pair of protrusions 81B.

The boom 3 further includes four coupling pins 50 used for the four connectors 80. Each of the pair of protrusions 81B of the first connector part 81 includes a pin hole 81H which is a hole into which the coupling pin 50 is inserted, and the protrusion 82B of the second connector part 82 includes a pin hole 82H which is a hole into which the coupling pin 50 is inserted. The pin hole 81H is a through hole penetrating the protrusion 81B in the left-right direction, and the pin hole 82H is a through hole penetrating the protrusion 82B in the left-right direction. In a state where the protrusion 82B is arranged between the pair of protrusions 81B, the pin holes 81H of the pair of protrusions 81B and the pin hole 82H of the protrusion 82B are arranged at the same position in side view. In this state, the coupling pin 50 is inserted into the pin holes 81H and 82H, thereby coupling the first connector part 81 and the second connector part 82 to each other. The intermediate boom member 3B and the intermediate boom member 3C are coupled to each other by coupling the four connectors 80 by the four coupling pins 50, respectively. A structure of the coupling pins 50 will be described later.

As illustrated in FIG. 1, the jib 4 includes a jib proximal end portion (jib foot) which is a proximal end portion supported by the boom 3 so as to be rotatable about a rotation center axis extending in the left-right direction, and a jib distal end portion which is a distal end portion located on the side opposite to the jib proximal end portion in the longitudinal direction of the jib 4. The jib 4 is what is called a lattice type jib, and includes a plurality of jib members. The jib 4 has a structure in which a plurality of jib members is arranged and coupled in a line in the longitudinal direction of the jib 4. The plurality of jib members includes a lower jib member 4A including the jib proximal end portion, an intermediate jib member 4B, and an upper jib member 4C including the jib distal end portion. A jib point sheave S4 is rotatably attached to the jib distal end portion. The plurality of jib members may include a plurality of intermediate jib members. In addition, the intermediate jib members can be omitted.

In the present embodiment, the crane 100 further includes a mast 5, a strut 6, a pair of left and right strut guylines 7, a pair of left and right boom guylines 8, a pair of left and right jib guylines 17, a main winding rope 9, an auxiliary winding rope 10, a boom raising/lowering rope 18, a main winding hook 11, an auxiliary winding hook 12, a main winding winch 13, an auxiliary winding winch 14, and a boom raising/lowering winch 15. The mast 5 is an example of a support member.

The mast 5 is supported by the upper slewing body 2 behind the boom 3. A sheave block 19A is connected to a distal end portion of the mast 5, and a sheave block 19B is arranged below the sheave block 19A with an interval. In the sheave block, a plurality of sheaves is arranged in the width direction (left-right direction). The pair of left and right boom guylines 8 connects the distal end portion of the mast 5 and the boom distal end portion.

The strut 6 is supported by the jib proximal end portion of the jib 4 or the boom distal end portion of the boom 3 behind the jib 4. The strut 6 includes a raising/lowering member connection portion connected to the jib proximal end portion of the jib 4 or the boom distal end portion of the boom 3, and a guyline connection portion to which the strut guyline 7 is connected. The strut 6 may be supported by the jib proximal end portion or the boom distal end portion so as to be rotatable about a rotation center axis extending in the left-right direction. As illustrated in FIG. 2, in the present embodiment, the strut 6 includes a strut body 6A and a link member 6B.

The strut body 6A includes a pair of left and right posts 601 and 601 arranged with an interval in the left-right direction, and at least one beam member extending in the left-right direction so as to connect these posts. Each of the pair of posts 601 and 601 includes a post proximal end portion (an example of the raising/lowering member connection portion) which is a proximal end portion connected to the jib proximal end portion (the proximal end portion of the lower jib member 4A) of the jib 4, and a post distal end portion which is a distal end portion located on an opposite side of the post proximal end portion. Specifically, the post proximal end portion of the post 601 on the right side is connected to a portion on the right side of the jib proximal end portion of the jib 4, and the post proximal end portion of the post 601 on the left side is connected to a portion on the left side of the jib proximal end portion of the jib 4. Each of the pair of posts 601 and 601 extends in a direction away from the jib proximal end portion of the jib 4. Each of the pair of posts 601 and 601 is arranged in an attitude standing upward from the jib proximal end portion of the jib 4 in a state where the boom 3 and the jib 4 are arranged in the lying attitude.

The link member 6B includes a pair of left and right arm portions 602 and 602 and a coupling portion 603 extending in the left-right direction so as to couple these arm portions 602 and 602. The link member 6B is an example of the guyline connection portion. Each of the pair of arm portions 602 and 602 includes an arm proximal end portion and an arm distal end portion, the arm proximal end portions of the arm portions being connected to the post distal end portions of the pair of posts 601 and 601 respectively, the arm distal end portion being located on the opposite side of the arm portion 602 in the longitudinal direction with respect to the arm proximal end portion. As illustrated in FIG. 3, the interval in the left-right direction between the arm distal end portion of the right arm portion 602 and the arm distal end portion of the left arm portion 602 is larger than a width in the left-right direction at the distal end portion of the strut body 6A (the interval between the post distal end portion of the right post 601 and the post distal end portion of the left post 601). The coupling portion 603 couples the arm distal end portion of the right arm portion 602 and the arm distal end portion of the left arm portion 602.

As illustrated in FIGS. 1 to 3, the pair of strut guylines 7 is stretched between the boom 3 and the strut 6. Specifically, each of the pair of strut guylines 7 is stretched between the intermediate portion of the boom 3 and the link member 6B of the strut 6. The intermediate portion of the boom 3 is any portion located between the boom proximal end portion and the boom distal end portion of the boom 3. In the present embodiment, the intermediate portion of the boom 3 is a portion where the intermediate boom member 3B and the intermediate boom member 3C are connected to each other or a portion in the vicinity thereof.

Each of the pair of strut guylines 7 includes a boom-side connection portion 70 (connection link) connected to the intermediate portion of the boom 3, a strut-side connection portion 74 connected to the link member 6B of the strut 6, and a guyline body which is a rope portion between these connection portions 70 and 74. A connection structure between the boom-side connection portion 70 and the intermediate portion of the boom 3 will be described later. Note that the link member 6B can be omitted, and in this case, the strut-side connection portions 74 of the pair of strut guylines 7 may be connected to the strut body 6A of the strut 6.

The pair of jib guylines 17 is stretched between the strut 6 and the jib 4. Specifically, each of the pair of jib guylines 17 is stretched between the strut body 6A of the strut 6 and the jib distal end portion of the jib 4.

The boom raising/lowering rope 18 illustrated in FIG. 1 is pulled out from the boom raising/lowering winch 15, and wound a plurality of times between the sheave block 19A and the sheave block 19B.

The boom raising/lowering winch 15 is arranged on the upper slewing body 2. The boom raising/lowering winch 15 winds up and winds out the boom raising/lowering rope 18 to change the distance between the sheave block 19A and the sheave block 19B. Thus, the boom 3 is raised and lowered with respect to the upper slewing body 2.

The main winding winch 13 winds up and winds down the main winding hook 11 by winding up and winding out the main winding rope 9. The main winding rope 9 pulled out from the main winding winch 13 extends downward from the jib distal end portion of the jib 4 via the guide sheave S1 and the jib point sheave S4 to support the main winding hook 11. In the present embodiment, the main winding winch 13 is arranged on the upper slewing body 2, but may be arranged on the boom 3.

The auxiliary winding winch 14 winds up and winds down the auxiliary winding hook 12 by winding up and winding out the auxiliary winding rope 10. The auxiliary winding rope 10 pulled out from the auxiliary winding winch 14 extends downward from the boom distal end portion of the boom 3 via the guide sheave S2 and the boom point sheave S3 to support the auxiliary winding hook 12. In the present embodiment, the auxiliary winding winch 14 is arranged on the upper slewing body 2, but may be arranged on the boom 3.

When the crane 100 is transported, the crane 100 is disassembled into a plurality of parts and assembled at a destination which is a transportation destination. The assembling work of the crane 100 includes a strut guyline connecting work that is a work of connecting each of the pair of strut guylines 7 to the intermediate portion of the boom 3. The disassembly work of the crane 100 includes a strut guyline removal work which is a work of removing each of the pair of strut guylines 7 from the intermediate portion of the boom 3. Hereinafter, the strut guyline connecting work and the strut guylinc removal work may be referred to as a connecting work and a removal work. Each of the connecting work and the removal work is performed in a state where the boom 3 and the jib 4 are in a lying state. That is, in each of the connecting work and the removal work, the boom 3 and the jib 4 are arranged in the lying attitude so that the longitudinal directions of the boom 3 and the jib 4 are in a direction along the ground. The lying attitude of the boom 3 and the jib 4 is, for example, an attitude in which the boom 3 and the jib 4 are inclined so as to be closer to the ground than the attitude of the boom 3 and the jib 4 illustrated in FIG. 2.

In a conventional crane, one end portions of a pair of left and right strut guylines are usually connected to left and right portions (lying upper portions) located on an upper portion of a boom in a state where the boom and the jib are arranged in a lying attitude. One end portion of each of the pair of strut guylines is connected to the lying upper portion via what is called a banana link. The banana link has a bent shape instead of a linear shape in order to avoid interference with the main pipe of the intermediate boom member. In the connecting work and the removal work of the conventional crane, in a state where the boom and the jib are arranged in the lying attitude, it is necessary for the worker to ascend to the lying upper portion of the boom and descend from the lying upper portion of the boom. Thus, it takes time to perform the connecting work and the removal work. Further, since the boom-side connection portion (connection link) which is one end portion of the strut guyline is a heavy object, it takes a long time to move the connection link to a high position corresponding to the lying upper portion of the boom using an auxiliary crane. In addition, it takes cost and time to ensure the safety of the connecting work and the removal work at a high position corresponding to the lying upper portion of the boom.

On the other hand, in the crane 100 according to the present embodiment, the boom-side connection portions 70 and 70 (connection links), which are one end portions of the pair of left and right strut guylines 7, are connected to the lying lower portions P1 and P1 (see FIG. 2), which are portions located at a lower portion of the boom 3 in a state where the boom 3 and the jib 4 are arranged in the lying attitude. Therefore, in the connecting work and the removal work of the crane 100 according to the present embodiment, the worker does not need to ascend to the lying upper portion P2 which is a portion located on an upper portion of the boom 3 in a state where the boom 3 and the jib 4 are arranged in the lying attitude. Thus, the connecting work and the removal work are shortened as compared with the conventional art. In addition, it is not necessary to move the boom-side connection portion 70 (connection link) to a high position corresponding to the lying upper portion P2 of the boom 3 using the auxiliary crane.

Furthermore, since the connecting work and the removal work at a high position corresponding to the lying upper portion P2 of the boom 3 become unnecessary, the cost and time required for safety measures can be reduced as compared with the conventional art.

The four connectors 80 include a lower right connector 80 arranged at a lower right position, a lower left connector 80 arranged at a lower left position, an upper right connector 80 arranged at an upper right position, and an upper left connector 80 arranged at an upper left position in a state where the boom 3 and the jib 4 are arranged in the lying attitude. Each of the lower right connector 80 and the lower left connector 80 is an example of a specific connector. Each of the lower right connector 80 and the lower left connector 80 may be referred to as a specific connector 80A. The lower right connector 80 and the lower left connector 80 are arranged at positions corresponding to the left and right lying lower portions P1 and P1 (see FIG. 2) of the boom 3, respectively, and the upper right connector 80 and the upper left connector 80 are arranged at positions corresponding to the left and right lying upper portions P2 and P2 of the boom 3, respectively.

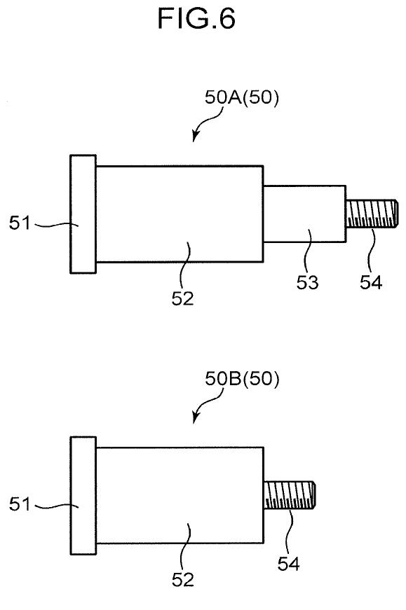

In the present embodiment, the four coupling pins 50 include two first coupling pins 50A and 50A illustrated in the upper diagram of FIG. 6 and two second coupling pins 50B and 50B illustrated in the lower diagram of FIG. 6. The two first coupling pins 50A and 50A are arranged at positions corresponding to the lying lower portions P1 and P1 of the boom 3, and the two second coupling pins 50B and 50B are arranged at positions corresponding to the lying upper portions P2 and P2 of the boom 3. Each of the first coupling pins 50A and 50A is an example of a specific coupling pin.

The first coupling pins 50A and 50A are respectively inserted into the pin holes 81H and 82H of the first connector part 81 and the second connector part 82, and position the boom-side connection portion 70 of the strut guyline 7 to the first coupling pin 50A. Thus, the first connector part 81 and the second connector part 82 are coupled to each other, the boom-side connection portion 70 of the strut guyline 7 is fixed to the first coupling pin 50A, and the strut guyline 7 is stretched between the boom 3 and the strut 6. On the other hand, the second coupling pins 50B and 50B are respectively inserted into the pin holes 81H and 82H of the first connector part 81 and the second connector part 82, but do not position the boom-side connection portion 70 of the strut guyline 7.

As illustrated in the upper view of FIG. 6, each of the first coupling pins 50A and 50A includes a head portion 51, a pin hole arrangement portion 52, a guyline attachment portion 53, and a retaining member attachment portion 54. The head portion 51, the pin hole arrangement portion 52, the guyline attachment portion 53, and the retaining member attachment portion 54 are arranged in this order along an axial direction of the first coupling pin 50A. In the present embodiment, the head portion 51 is located at a proximal end portion of the first coupling pin 50A, and the retaining member attachment portion 54 is located at a distal end portion of the first coupling pin 50A. The first coupling pin 50A is inserted into the pin holes 81H and 82H of the first connector part 81 and the second connector part 82 from an inside (the left side in FIG. 4) in a width direction of the boom 3 toward an outside (the right side in FIG. 4) in the width direction with respect to the first connector part 81 and the second connector part 82. Thus, the first coupling pin 50A is supported by the specific connector 80A in an attitude in which the axial direction of the first coupling pin 50A is in the left-right direction.

As illustrated in FIG. 4, a dimension (outer diameter) of the head portion 51 in a direction orthogonal to the axial direction of the first coupling pin 50A is larger than the pin holes 81H and 82H of the first connector part 81 and the second connector part 82. Thus, the head portion 51 can prevent the first coupling pin 50A from coming out of the pin holes 81H and 82H to one side (the right side in FIG. 4) in the axial direction of the first coupling pin 50A. In the present embodiment, the head portion 51 has a disk shape, but the shape of the head portion 51 is not limited to the disk shape.

The pin hole arrangement portion 52 includes portions to be arranged in the pin holes 81H and 82H of the first connector part 81 and the second connector part 82. The pin hole arrangement portion 52 is a columnar portion extending from the head portion 51 in the axial direction of the first coupling pin 50A, and has an outer diameter slightly smaller than the pin holes 81H and 82H of the first connector part 81 and the second connector part 82. The pin hole arrangement portion 52 has such an axial length that the distal end portion of the pin hole arrangement portion 52 is arranged outside the pin holes 81H and 82H in a state where the first coupling pin 50A is inserted into the pin holes 81H and 82H of the first connector part 81 and the second connector part 82. Further, an outer diameter of pin hole arrangement portion 52 is larger than an inner diameter of a pin hole 73H of a pin connection portion 73 to be described later in the boom-side connection portion 70. Thus, the boom-side connection portion 70 of the strut guyline 7 can be fixed to the first coupling pin 50A with a gap formed between the boom-side connection portion 70 and an outer surface of the connector 80, specifically, an outer surface (the right side surface in FIG. 4) of the first connector part 81. Note that FIG. 4 is a plan view of a portion corresponding to the right lying lower portion P1 out of the left and right lying lower portions P1 and P1 in the boom 3, and FIG. 5 is a side view of a portion corresponding to the right lying lower portion P1.

The guyline attachment portion 53 is a portion to which the boom-side connection portion 70 of the strut guyline 7 is detachably attached. The guyline attachment portion 53 is a portion projecting in the axial direction of the first coupling pin 50A from the pin hole arrangement portion 52 on the side opposite to the head portion 51. In the present embodiment, the guyline attachment portion 53 has a columnar shape and has an outer diameter smaller than that of the pin hole arrangement portion 52. Note that the shape of the guyline attachment portion 53 is not limited to the columnar shape, and may be another shape (for example, a prismatic column shape) to which the boom-side connection portion 70 can be attached.

As illustrated in FIGS. 4 and 5, the boom-side connection portion 70 (connection link) of the strut guyline 7 includes a fixing portion 71 which is a portion to which one end portion of the guyline body is fixed, and a pin connection portion 73 which is a portion connected to the guyline attachment portion 53 of the first coupling pin 50A. In the present embodiment, the pin connection portion 73 includes a pair of protruding pieces protruding from the fixing portion 71 in a longitudinal direction of the strut guyline 7. The pin hole 73H into which the guyline attachment portion 53 of the first coupling pin 50A is inserted is formed in each of the protruding pieces. The pin hole 73H is a through hole penetrating the protruding piece of the pin connection portion 73 in the left-right direction. The pin hole 73H of the pin connection portion 73 of the boom-side connection portion 70 has an inner diameter slightly larger than the outer diameter of the guyline attachment portion 53.

The boom 3 further includes at least one retaining member. The retaining member attachment portion 54 is a portion to which the at least one retaining member is attached. The retaining member attachment portion 54 is a portion projecting in the axial direction of the first coupling pin 50A from the guyline attachment portion 53 on the side opposite to the head portion 51. As illustrated in FIG. 4, in a state where the head portion 51 is in contact with or proximity to an inner surface of the connector 80, specifically, an inner surface (the left side surface in FIG. 4) of the first connector part 81, the pin hole arrangement portion 52 is arranged in the pin holes 81H and 82H of the first connector part 81 and the second connector part 82, and the guyline attachment portion 53 is arranged in the pin holes 73H of the pin connection portion 73, the retaining member attachment portion 54 projects outward (rightward in FIG. 4) in the width direction of the boom 3 from the pin connection portion 73.

In the present embodiment, the at least one retaining member includes a washer 101 and a nut 102, and the retaining member attachment portion 54 has a shape like a bolt (male screw). That is, a screw thread is formed on an outer peripheral surface of the retaining member attachment portion 54. As illustrated in FIGS. 4 and 5, in a state where the first coupling pin 50A is inserted into the pin holes 81H and 82H of the first connector part 81 and the second connector part 82 and the pin holes 73H of the pin connection portion 73, the washer 101 is attached to the retaining member attachment portion 54, and the nut 102 is screwed onto the retaining member attachment portion 54. Thus, the boom-side connection portion 70 of the strut guyline 7 is positioned to the first coupling pin 50A, and the boom-side connection portion 70 is prevented from coming off from the first coupling pin 50A and falling off.

As illustrated in FIG. 4, in the present embodiment, the boom-side connection portion 70 of the right strut guyline 7 is arranged at a position adjacent to the lower right connector 80 on the right side with respect to the lower right connector 80 (specific connector 80A), that is, on the outside in the width direction of the boom 3 with respect to the lower right connector 80. Further, although not illustrated, the boom-side connection portion 70 of the left strut guyline 7 is arranged at a position adjacent to the lower left connector 80 on the left side with respect to the lower left connector 80 (specific connector 80A), that is, on the outside in the width direction of the boom 3 with respect to the lower left connector 80. This enables the left and right boom-side connection portions 70 to be fixed to a position adjacent to the lower right connector 80 and a position adjacent to the lower left connector 80, respectively, without the left and right strut guylines 7 interfering with the intermediate boom member 3C of the boom 3.

Note that, as described above, each of the second coupling pins 50B and 50B is inserted into the pin holes 81H and 82H of the first connector part 81 and the second connector part 82, but it is not necessary to position the boom-side connection portion 70 of the strut guyline 7. Therefore, as illustrated in the lower diagram of FIG. 6, each of the second coupling pins 50B and 50B includes the head portion 51, the pin hole arrangement portion 52, and the retaining member attachment portion 54 similarly to the first coupling pin 50A, but does not include the guyline attachment portion 53 of the first coupling pin 50A. Therefore, in each of the second coupling pins 50B and 50B, the retaining member attachment portion 54 projects in the axial direction of the second coupling pin 50B from the pin hole arrangement portion 52 on the side opposite to the head portion 51.

As described above, the crane 100 according to the present embodiment can improve workability of the strut guyline connecting work and the strut guyline removal work.

Further, in the present embodiment, the boom-side connection portion 70 of the strut guyline 7 is arranged at a position adjacent to the specific connector 80A on the outside in the width direction of the boom 3 with respect to the specific connector 80A. Therefore, the boom-side connection portion 70 of the strut guyline 7 can be arranged at the position on the outside in the width direction of the boom 3 with respect to the specific connector 80A, and the guyline body of the strut guyline 7 can be extended from the position toward the strut 6, so that the strut guyline 7 can be easily prevented from interfering with the boom 3 as illustrated in FIG. 3.

Further, in the present embodiment, the width in the left-right direction at the distal end portion of the strut body 6A is smaller than an interval between the boom-side connection portion 70 of the right strut guyline 7 and the boom-side connection portion 70 of the left strut guyline 7. The strut 6 includes the strut body 6A and the link member 6B supported by the strut body 6A. The link member 6B can position the strut-side connection portion 74 outside the post 601 of the strut body 6A in the width direction of the boom 3. This makes it easy to avoid the strut guyline 7 from interfering with the boom guyline 8.

Further, in the present embodiment, the first coupling pin 50A (specific coupling pin) couples the first connector part 81 and the second connector part 82 of the specific connector 80A, and positions the boom-side connection portion 70 of the strut guyline 7, so that an increase in the number of components can be suppressed.

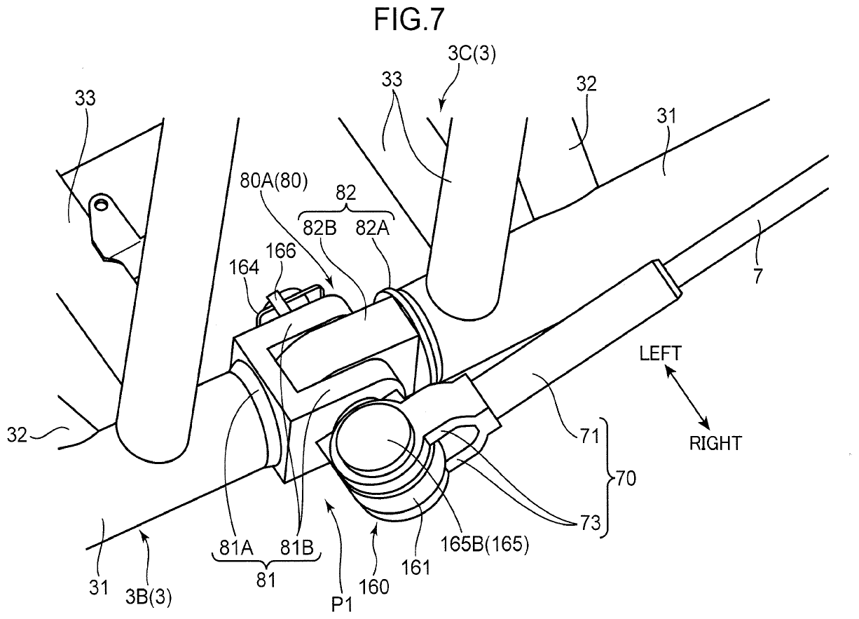

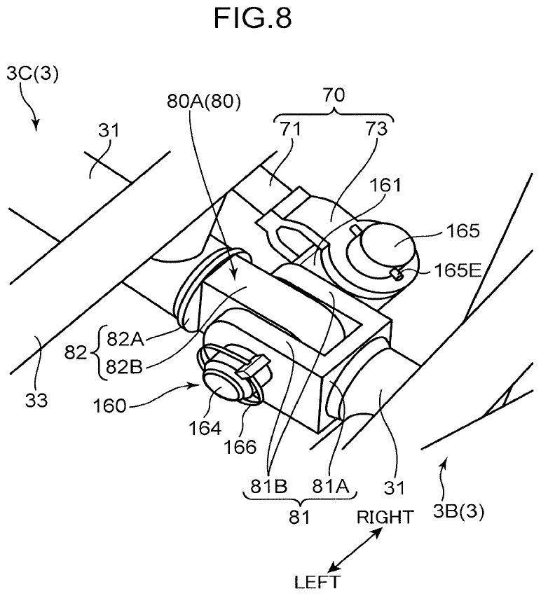

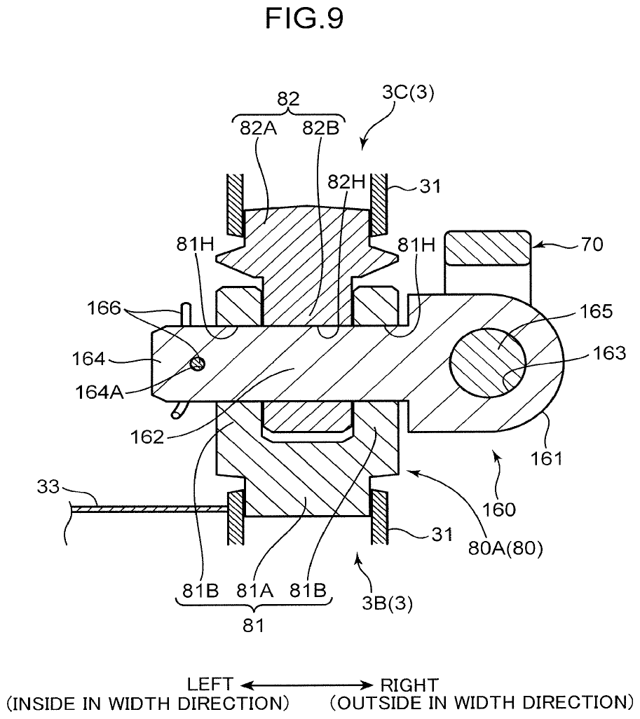

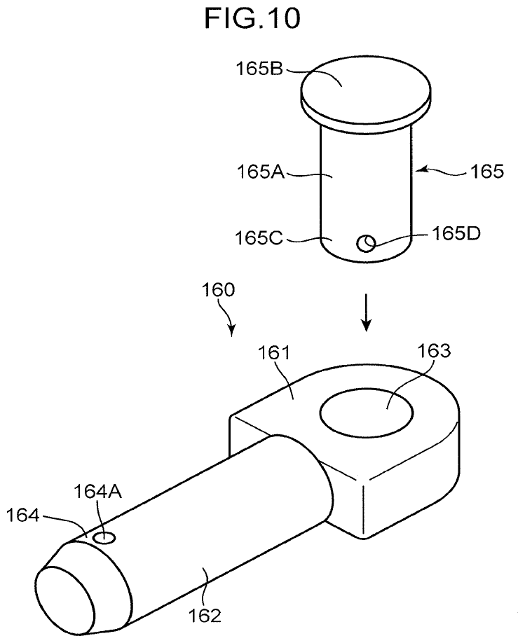

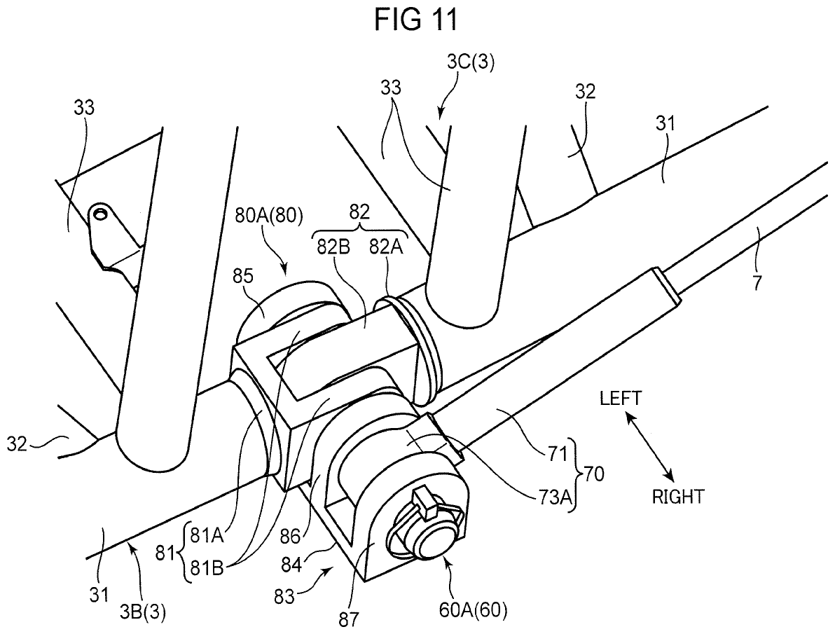

FIGS. 7 to 10 illustrate a modification of the present embodiment. FIG. 7 is a view of a connection structure for connecting the boom-side connection portion 70 of the strut guyline 7 to the boom 3 in the crane 100 according to the modification as viewed obliquely from above, FIG. 8 is a view of the connection structure as viewed obliquely from below, and FIG. 9 is a cross-sectional view of the connection structure. FIG. 10 is a perspective view illustrating a first coupling pin 160 used in the connection structure. Note that the crane 100 according to the modification has a structure similar to that of the crane 100 according to the embodiment illustrated in FIGS. 1 to 6 except for the connection structure. Therefore, the connection structure according to the modification will be mainly described below.

The first coupling pin 160 according to the modification illustrated in FIG. 10 is arranged at a position similar to that of the first coupling pin 50A illustrated in FIG. 6, that is, at a position corresponding to each of the lying lower portions P1 and P1 located at the lower portion of the boom 3 in a state where the boom 3 and the jib 4 are arranged in the lying attitude.

As illustrated in FIG. 10, the first coupling pin 160 includes a pin body and a fixing member 165. The pin body includes a head portion 161, a pin hole arrangement portion 162, and a retaining member attachment portion 164. The head portion 161, the pin hole arrangement portion 162, and the retaining member attachment portion 164 are arranged in this order along the axial direction of the first coupling pin 160. The head portion 161 is located at a proximal end portion of the first coupling pin 160, and the retaining member attachment portion 164 is located at a distal end portion of the first coupling pin 160. In this modification, the fixing member 165 is configured as a member different from the pin body, and is attached to the head portion 161. The first coupling pin 160 is inserted into the pin holes 81H and 82H of the first connector part 81 and the second connector part 82 from the outside (the right side in FIG. 9) in the width direction of the boom 3 toward the inside (the left side in FIG. 9) in the width direction with respect to the first connector part 81 and the second connector part 82.

As illustrated in FIG. 9, a dimension of the head portion 161 of the first coupling pin 160 in a direction orthogonal to an axial direction of the pin body is larger than the pin holes 81H and 82H of the first connector part 81 and the second connector part 82. Thus, the head portion 161 can prevent the first coupling pin 160 from coming out of the pin holes 81H and 82H to one side (the left side in FIG. 9) in the axial direction of the first coupling pin 160. The head portion 161 includes a through hole 163 penetrating the head portion 161 in a direction orthogonal to the axial direction of the first coupling pin 160. The fixing member 165 is inserted into the through hole 163.

The pin hole arrangement portion 162 and the retaining member attachment portion 164 are portions aligned in the axial direction of the first coupling pin 160 and have a columnar shape. The pin hole arrangement portion 162 includes portions arranged in the pin holes 81H and 82H of the first connector part 81 and the second connector part 82. The pin hole arrangement portion 162 and the retaining member attachment portion 164 have outer diameters slightly smaller than the pin holes 81H and 82H of the first connector part 81 and the second connector part 82.

The retaining member attachment portion 164 is arranged outside the pin holes 81II and 82H (on the left side in FIG. 9) in a state where the pin hole arrangement portion 162 is arranged in the pin holes 81H and 82H of the first connector part 81 and the second connector part 82. The retaining member attachment portion 164 is a portion projecting in the axial direction of the first coupling pin 160 from the pin hole arrangement portion 162 on the side opposite to the head portion 161. As illustrated in FIG. 9, in a state where the head portion 161 is in contact with or proximity to an outer surface of the specific connector 80A, specifically, an outer surface (the right side surface in FIG. 9) of the first connector part 81, and the pin hole arrangement portion 162 is arranged in the pin holes 81H and 82H of the first connector part 81 and the second connector part 82, the retaining member attachment portion 164 projects inward (the left side in FIG. 9) in the width direction from the inner surface of the specific connector 80A, specifically, the inner surface (the left side surface in FIG. 9) of the first connector part 81.

The boom 3 of the crane 100 according to the modification further includes a retaining member 166. The retaining member attachment portion 164 is a portion to which the retaining member 166 is attached. A through hole 164A penetrating the retaining member attachment portion 164 in a direction orthogonal to the axial direction of the pin body of the first coupling pin 160 is formed in the retaining member attachment portion 164.

In this modification, the retaining member 166 includes an insertion portion that is a portion to be inserted into the through hole 164A of the retaining member attachment portion 164, and an annular portion connected to one end of the insertion portion and having a shape surrounding an outer periphery of the retaining member attachment portion 164. As illustrated in FIGS. 8 and 9, in a state where the first coupling pin 160 is inserted into the pin holes 81H and 82H of the first connector part 81 and the second connector part 82, the insertion portion of the retaining member 166 is inserted into the through hole 164A of the retaining member attachment portion 164, and the annular portion of the retaining member 166 is arranged so as to surround the outer periphery of the retaining member attachment portion 164. Thus, the first coupling pin 160 is fixed to the first connector part 81 and the second connector part 82.

The guyline attachment portion is a portion to which the boom-side connection portion 70 of the strut guyline 7 is detachably attached. In this modification, the guyline attachment portion includes the head portion 161 of the pin body and the fixing member 165. The fixing member 165 is a columnar (pin-shaped) member to be inserted into the through hole 163 of the head portion 161. In the present embodiment, the fixing member 165 includes a pin (a flanged pin) and a retaining member. The fixing member 165 includes an intermediate portion 165A arranged in the through hole 163 of the head portion 161 when inserted into the through hole 163, an attachment end portion 165B which is one end portion extending from the intermediate portion 165A to one side in the axial direction of the fixing member 165 and arranged outside the through hole 163, and an attachment end portion 165° C. which is the other end portion extending from the intermediate portion 165A to the other side in the axial direction of the fixing member 165 and arranged outside the through hole 163.

As illustrated in FIGS. 7 and 8, the boom-side connection portion 70 (connection link) of the strut guyline 7 includes a fixing portion 71 which is a portion to which one end portion of the guyline body is fixed, and a pin connection portion 73 which is a portion connected to the fixing member 165 of the first coupling pin 160. The pin connection portion 73 includes a pair of protruding pieces protruding from the fixing portion 71 in the longitudinal direction of the strut guyline 7. A through hole into which the fixing member 165 of the first coupling pin 160 is inserted is formed in each of the protruding pieces. As illustrated in FIG. 10, the attachment end portion 165B has an outer diameter larger than the through hole of the protruding piece of the pin connection portion 73. The intermediate portion 165A and the attachment end portion 165C have outer diameters slightly smaller than the through hole of the protruding piece in the pin connection portion 73 and the through hole 163 of the head portion 161. The intermediate portion 165A and the attachment end portion 165C of the fixing member 165 are inserted into the through holes of the pair of protruding pieces in the pin connection portion 73 and the through hole 163 of the head portion 161, and a retaining member 165E (see FIG. 8) is inserted into a through hole 165D (see FIG. 10) formed in the attachment end portion 165° C. arranged outside the through holes of the protruding pieces and the through hole 163 of the head portion 161. Accordingly, the boom-side connection portion 70 of the strut guyline 7 is positioned in the first coupling pin 160.

In this modification, the specific coupling pin includes the pin body having a pin shape and the fixing member 165 having a pin shape, the pin body is supported by the specific connector so as to be rotatable about an axis thereof, and the boom-side connection portion 70 of the strut guyline 7 is supported so as to be rotatable about the fixing member 165. This makes it possible to adjust the extending direction of the strut guyline 7 not only in the up-down direction but also in the left-right direction. Therefore, in this modification, the workability of the strut guyline connecting work and the strut guyline removal work can be further improved as compared with the embodiment illustrated in FIG. 4. Further, when the strut guyline 7 does not interfere with the boom 3 (specifically, the intermediate boom member 3C) even if the link member 6B is omitted, the direction in which the strut guyline 7 extends can be adjusted by rotating the boom-side connection portion 70 in the left-right direction around the fixing member 165, and the strut-side connection portion 74 can be easily connected to the strut body 6A of the strut 6.

The present disclosure is not limited to the embodiment described above. The present disclosure includes, for example, the following modes.

### (A) Position of Boom-Side Connection Portion of Strut Guyline

In the above embodiment, the boom-side connection portion 70 of the strut guyline 7 is arranged at a position adjacent to the specific connector 80A on the outside in the width direction of the boom 3 with respect to the specific connector 80A, but may be arranged at a position adjacent to the specific connector 80A on the inside in the width direction of the boom 3 with respect to the specific connector 80A. Specifically, the boom-side connection portion 70 of the right strut guyline 7 may be arranged on the left side with respect to the lower right connector 80 (specific connector 80A), that is, on the inside in the width direction of the boom 3 with respect to the lower right connector 80 at a position adjacent to the lower right connector 80 in the left-right direction. In addition, the boom-side connection portion 70 of the left strut guyline 7 may be arranged on the right side with respect to the lower left connector 80 (specific connector 80A), that is, on the inside in the width direction of the boom 3 with respect to the lower left connector 80 at a position adjacent to the lower left connector 80 in the left-right direction. In this case, the left and right in the direction of the first coupling pin 50 are opposite to those in FIG. 4. Similarly, in the crane 100 according to the modification, the boom-side connection portion 70 of the strut guyline 7 may be arranged at a position adjacent to the specific connector 80A on the inside in the width direction of the boom 3 with respect to the specific connector 80A.

### (B) Specific Coupling Pin

In the above embodiment, the head portion 51, the pin hole arrangement portion 52, the guyline attachment portion 53, and the retaining member attachment portion 54 are arranged in this order along the axial direction of the first coupling pin 50A, but the arrangement order of these portions is not limited to the above embodiment. For example, the head portion 51, the guyline attachment portion 53, the pin hole arrangement portion 52, and the retaining member attachment portion 54 may be arranged in this order along the axial direction of the first coupling pin 50A (specific coupling pin 50A). In this case, the boom-side connection portion 70 of the strut guyline 7 is attached to the guyline attachment portion 53 between the head portion 51 and the specific connector 80A. In this case, the insertion direction of the specific coupling pin 50A may be a direction (direction from the inside to the outside) in which the head portion 51 is located on the inside in the width direction of the boom 3 with respect to the specific connector 80A, or may be a direction (direction from the outside to the inside) in which the head portion 51 is located outside the width direction of the boom 3 with respect to the specific connector 80A. In a case where the insertion direction is the direction from the inside to the outside, the boom-side connection portion 70 of the strut guyline 7 is arranged between the head portion 51 and the specific connector 80A on the inside in the width direction of the boom 3 with respect to the specific connector 80A. In a case where the insertion direction is the direction from the outside to the inside, the boom-side connection portion 70 of the strut guyline 7 is arranged between the head portion 51 and the specific connector 80A outside the specific connector 80A in the width direction of the boom 3. In this modification, the retaining member attached to the retaining member attachment portion 54 may include the washer 101 and the nut 102 as illustrated in FIG. 4, or may include the retaining member 166 as illustrated in FIG. 8.

### (C) Strut

In the above embodiment, the width in the left-right direction at the distal end portion of the strut body 6A is smaller than the interval between the boom-side connection portion 70 of the right strut guyline 7 and the boom-side connection portion 70 of the left strut guyline 7, but the width in the left-right direction at the distal end portion of the strut body 6A may be substantially the same as the distance between the left and right boom-side connection portions 70. In this case, the link member 6B of the strut 6 can be omitted.

### (D) Crane Specifications

In the above embodiment, the machine body is a self-travelling crane including the lower travelling body, but the machine body may be, for example, fixed to the ground and incapable of self-travelling. In addition, the crane 100 according to the present embodiment is what is called a fixed jib specification crane, but may be a crane capable of changing the angle of the jib 4 with respect to the boom 3.

### (E) Support Member

In the above embodiment, the support member is constituted of the mast 5, but the support member may be, for example, a gantry. The gantry is supported by the upper slewing body 2 behind the boom 3, and is connected to the distal end portion of the boom 3 via, for example, a boom guyline.

Next, a crane 100 according to a second embodiment will be described with reference to FIGS. 11 to 16. The basic structure of the crane 100 according to the second embodiment is similar to that of the crane 100 according to the first embodiment already described with reference to FIGS. 1 to 3, and thus the description thereof will be omitted.

In the second embodiment, the boom 3 includes four connectors 80 and four coupling pins 60 for coupling the intermediate boom member 3B and the intermediate boom member 3C. That is, the boom 3 of the crane 100 according to the first embodiment includes the four coupling pins 50 as illustrated in FIGS. 1 to 3, but the boom 3 of the crane 100 according to the second embodiment includes four coupling pins 60 instead of the four coupling pins 50. In the second embodiment, the four connectors 80 and the four coupling pins 60 connect the four main pipes 31 of the intermediate boom member 3B and the four main pipes 31 of the intermediate boom member 3C. Thus, the intermediate boom member 3B and the intermediate boom member 3C are coupled to each other.

The four connectors 80 include a lower right connector 80 arranged at a lower right position, a lower left connector 80 arranged at a lower left position, an upper right connector 80 arranged at an upper right position, and an upper left connector 80 arranged at an upper left position in a state where the boom 3 and the jib 4 are arranged in the lying attitude. The lower right connector 80 and the lower left connector 80 are arranged at positions corresponding to the left and right lying lower portions P1 and P1 (see FIG. 2) of the boom 3, respectively, and the upper right connector 80 and the upper left connector 80 are arranged at positions corresponding to the left and right lying upper portions P2 and P2 of the boom 3, respectively.

The lower right connector 80 is a connector having a structure that couples the main pipe 31 of the intermediate boom member 3B and the main pipe 31 of the intermediate boom member 3C, and to which the boom-side connection portion 70 of the right strut guyline 7 can be attached. The lower left connector 80 is a connector that couples the main pipe 31 of the intermediate boom member 3B and the main pipe 31 of the intermediate boom member 3C, and to which the boom-side connection portion 70 of the left strut guyline 7 can be attached. The lower right connector 80 and the lower left connector 80 have left and right symmetrical shapes. Each of the lower right connector 80 and the lower left connector 80 is an example of a specific connector. Hereinafter, each of the lower right connector 80 and the lower left connector 80 may be referred to as a specific connector 80A.

Each of the upper right connector 80 and the upper left connector 80 couples the main pipe 31 of the intermediate boom member 3B and the main pipe 31 of the intermediate boom member 3C. Each of the upper right connector 80 and the upper left connector 80 is a normal connector not having a structure for attaching the boom-side connection portion 70 of the strut guyline 7. Hereinafter, each of the upper right connector 80 and the upper left connector 80 may be referred to as a normal connector 80B.

The four coupling pins 60 include a lower right coupling pin 60 used for the lower right connector 80, a lower left coupling pin 60 used for the lower left connector 80, an upper right coupling pin 60 used for the upper right connector 80, and an upper left coupling pin 60 used for the upper left connector 80. That is, the lower right coupling pin 60 and the lower left coupling pin 60 are arranged at positions corresponding to the lying lower portions P1 and P1 of the boom 3, and the upper right coupling pin 60 and the upper left coupling pin 60 are arranged at positions corresponding to the lying upper portions P2 and P2 of the boom 3. Each of the lower right coupling pin 60 and the lower left coupling pin 60 is an example of a specific coupling pin. Hereinafter, each of the lower right coupling pin 60 and the lower left coupling pin 60 may be referred to as a specific coupling pin 60A, and each of the upper right coupling pin 60 and the upper left coupling pin 60 may be referred to as a normal coupling pin.

FIG. 11 is a perspective view illustrating the specific connector 80A arranged at a portion corresponding to the right lying lower portion P1 out of the left and right lying lower portions PI and P1 in the boom 3, and a peripheral structure thereof, and FIG. 13 is a cross-sectional view thereof. As illustrated in FIGS. 11 to 13, the specific connector 80A includes a first connector part 81, a second connector part 82, and a third connector part 83.

The first connector part 81 is attached to the main pipe distal end portion 312 of the main pipe 31 of the intermediate boom member 3B, and the second connector part 82 is attached to the main pipe proximal end portion 311 of the main pipe 31 of the intermediate boom member 3C. The first connector part 81 and the second connector part 82 are detachably coupled to each other. The third connector part 83 has a structure to which the boom-side connection portion 70 of the strut guyline 7 can be attached. The third connector part 83 is detachably coupled to the first connector part 81 and the second connector part 82.

Note that, although the normal connector 80B is not illustrated, the normal connector 80B includes the first connector part 81 and the second connector part 82 similar to those of the specific connector 80A, but does not include the third connector part 83 included in the specific connector 80A.

In the specific connector 80A, one of the first connector part 81 and the second connector part 82 is a male connector part having a male shape, and the other of the first connector part 81 and the second connector part 82 is a female connector part having a female shape. In the present embodiment, as illustrated in FIGS. 11 and 13, the first connector part 81 is a female connector part and the second connector part 82 is a male connector part, but these may have opposite shapes.

The first connector part 81 of the specific connector 80A includes an attachment portion 81A that is a portion attached to the main pipe distal end portion 312 of the main pipe 31 of the intermediate boom member 3B, and a pair of plate-shaped protrusions 81B protruding from the attachment portion 81A in the longitudinal direction of the main pipe 31. The pair of protrusions 81B is arranged with an interval in the left-right direction.

The second connector part 82 of the specific connector 80A includes an attachment portion 82A which is a portion attached to the main pipe proximal end portion 311 of the main pipe 31 of the intermediate boom member 3C, and a plate-shaped protrusion 82B protruding from the attachment portion 82A in the longitudinal direction of the main pipe 31. The thickness of the protrusion 82B is slightly smaller than the interval between the pair of protrusions 81B. Thus, the protrusion 82B can be arranged between the pair of protrusions 81B.

Each of the pair of protrusions 81B of the first connector part 81 includes a pin hole 81H which is a hole into which the specific coupling pin 60A is inserted, and the protrusion 82B of the second connector part 82 includes a pin hole 82H which is a hole into which the specific coupling pin 60A is inserted. The pin hole 81H is a through hole penetrating the protrusion 81B in the left-right direction, and the pin hole 82H is a through hole penetrating the protrusion 82B in the left-right direction. In a state where the protrusion 82B is arranged between the pair of protrusions 81B, the pin holes 81H of the pair of protrusions 81B and the pin hole 82H of the protrusion 82B are arranged at the same position in side view. In this state, the specific coupling pin 60A is inserted into the pin holes 81H and 82H, thereby coupling the first connector part 81 and the second connector part 82 to each other.

In the specific connector 80A, the first connector part 81 and the second connector part 82 constitute a connector body. The third connector part 83 of the specific connector 80A is connected to the connector body. In the present embodiment, the third connector part 83 is a member formed separately from the first connector part 81 and the second connector part 82. The third connector part 83 is integrally coupled to the first connector part 81 and the second connector part 82 by the specific coupling pin 60A.

As illustrated in FIGS. 11 to 13, the third connector part 83 includes a connector body attachment portion 88 which is a portion for detachably attaching the connector body, and a guyline attachment portion 89 which is a portion for detachably attaching the boom-side connection portion 70 of the strut guyline 7.

The third connector part 83 includes a base portion 84 and a plurality of wall portions. The base portion 84 is a portion extending along the left-right direction. The plurality of wall portions includes an inner wall portion 85, an intermediate wall portion 86, and an outer wall portion 87. The inner wall portion 85 is located on the inside (the left side in FIGS. 11 to 13) in the width direction of the boom 3 with respect to the intermediate wall portion 86 and the outer wall portion 87, and the outer wall portion 87 is located on the outside (the right side in FIGS. 11 to 13) in the width direction of the boom 3 with respect to the inner wall portion 85 and the intermediate wall portion 86. The inner wall portion 85, the intermediate wall portion 86, and the outer wall portion 87 are arranged with intervals in the left-right direction.

In the present embodiment, the base portion 84 has a plate-like shape extending in the left-right direction, and the inner wall portion 85, the intermediate wall portion 86, and the outer wall portion 87 each have a plate-like shape rising in a direction (upward in FIG. 11) orthogonal to the left-right direction from the base portion 84. The base portion 84 includes an inner portion that is a portion connecting an end portion of the inner wall portion 85 and an end portion of the intermediate wall portion 86, and an outer portion that is a portion connecting an end portion of the intermediate wall portion 86 and an end portion of the outer wall portion 87.

The connector body attachment portion 88 includes the inner wall portion 85, a part of the intermediate wall portion 86 (a left side portion of the intermediate wall portion 86), and the inner portion of the base portion 84. The first connector part 81 and the second connector part 82 constituting the connector body are arranged in a connector body arrangement space which is a space defined by the inner wall portion 85, the intermediate wall portion 86, and the inner portion of the base portion 84.

The guyline attachment portion 89 includes a part of the intermediate wall portion 86 (a right side portion of the intermediate wall portion 86), the outer wall portion 87, and the outer portion of the base portion 84. The boom-side connection portion 70 of the strut guyline 7 is arranged in a guyline arrangement space which is a space defined by the intermediate wall portion 86, the outer wall portion 87, and the outer portion of the base portion 84.

The inner wall portion 85 includes a pin hole 85H penetrating the inner wall portion 85 in the left-right direction, the intermediate wall portion 86 includes a pin hole 86H penetrating the intermediate wall portion 86 in the left-right direction, and the outer wall portion 87 includes a pin hole 87H penetrating the outer wall portion 87 in the left-right direction. These pin holes 85H, 86H, and 87H are formed at positions overlapping each other in a side view.

In a connector body arrangement state where the first connector part 81 and the second connector part 82 constituting the connector body are arranged in the connector body arrangement space of the third connector part 83, the pin holes 85H, 86H, and 87H of the third connector part 83 overlap the pin hole 81H of the first connector part 81 and the pin hole 82H of the second connector part 82 in side view. In addition, in a guyline arrangement state where the boom-side connection portion 70 of the strut guyline 7 is arranged in the guyline arrangement space of the third connector part 83, a pin hole 73H to be described later formed in the boom-side connection portion 70 can be arranged at a position overlapping the pin holes 81H, 82H, 85H, 86H, and 87H of the first to third connector parts 81 to 83 in side view.

Therefore, as illustrated in FIGS. 11 and 13, in the connector body arrangement state and the guyline arrangement state, the specific coupling pin 60A can be inserted into the pin hole 81H of the first connector part 81, the pin hole 82H of the second connector part 82, the pin holes 85H, 86H, and 87H of the third connector part 83, and the pin hole 73H of the boom-side connection portion 70. Thus, the first connector part 81 and the second connector part 82 are coupled to each other, the third connector part 83 is fixed to the connector body (the first connector part and the second connector part), the boom-side connection portion 70 of the strut guyline 7 is fixed to the third connector part 83, and the strut guyline 7 is stretched between the boom 3 and the strut 6.

Note that the normal coupling pin is inserted into the pin holes of the first connector part 81 and the second connector part 82 to couple the first connector part 81 and the second connector part 82 to each other, but does not position the boom-side connection portion 70 of the strut guyline 7.

As illustrated in FIG. 13, the specific coupling pin 60A includes a head portion 61, a connector body coupling portion 62, a guyline fixing portion 63, and a retaining member attachment portion 64. The head portion 61, the connector body coupling portion 62, the guyline fixing portion 63, and the retaining member attachment portion 64 are arranged in this order along an axial direction of the specific coupling pin 60A. In the present embodiment, the head portion 61 is located at a proximal end portion of the specific coupling pin 60A, and the retaining member attachment portion 64 is located at a distal end portion of the specific coupling pin 60A. In the present embodiment, the portions of the connector body coupling portion 62, the guyline fixing portion 63, and the retaining member attachment portion 64 of the specific coupling pin 60A have a substantially cylindrical shape. The specific coupling pin 60A is inserted into the pin holes 81H and 82H of the first connector part 81 and the second connector part 82 from the inside (the left side in FIG. 13) in the width direction of the boom 3 toward the outside (the right side in FIG. 13) in the width direction with respect to the first connector part 81 and the second connector part 82. Thus, the specific coupling pin 60A is supported by the specific connector 80A in an attitude in which the axial direction of the specific coupling pin 60A is in the left-right direction.

As illustrated in FIG. 13, a dimension (outer diameter) of the head portion 61 in a direction orthogonal to the axial direction of the specific coupling pin 60A is larger than the pin holes 81H and 82H of the first connector part 81 and the second connector part 82. Thus, the head portion 61 can prevent the specific coupling pin 60A from coming out of the pin holes 81H and 82H to one side (the right side in FIG. 11) in the axial direction of the specific coupling pin 60A. In the present embodiment, the head portion 61 has a disk shape, but the shape of the head portion 61 is not limited to the disk shape.

The connector body coupling portion 62 includes portions arranged in the pin holes 81H and 82H of the first connector part 81 and the second connector part 82. The first connector part 81 and the second connector part 82 are coupled to each other by arranging the connector body coupling portion 62 in the pin holes 81H and 82H. The connector body coupling portion 62 is a columnar portion extending from the head portion 61 in the axial direction of the specific coupling pin 60A, and has an outer diameter slightly smaller than the pin holes 81H and 82H of the first connector part 81 and the second connector part 82.

The guyline fixing portion 63 is a portion to which the boom-side connection portion 70 of the strut guyline 7 is attached. The guyline fixing portion 63 is a portion projecting in the axial direction of the specific coupling pin 60A from the connector body coupling portion 62 on the side opposite to the head portion 61. In the present embodiment, the guyline fixing portion 63 has a columnar shape.

As illustrated in FIGS. 11 and 13, the boom-side connection portion 70 of the strut guyline 7 includes a fixing portion 71 which is a portion to which one end portion of the guyline body is fixed, and an attached portion 73A which is a portion arranged in the guyline arrangement space of the third connector part 83 and attached to the guyline attachment portion 89. In the present embodiment, the attached portion 73A has a shape corresponding to the guyline arrangement space. The pin hole 73H into which the guyline fixing portion 63 of the specific coupling pin 60A is inserted is formed in the attached portion 73A. The pin hole 73H is a through hole penetrating the attached portion 73A in the left-right direction. The pin hole 73H of the attached portion 73A of the boom-side connection portion 70 has an inner diameter slightly larger than an outer diameter of the guyline fixing portion 63.

The boom 3 further includes a retaining member 66. The retaining member attachment portion 64 is a portion to which the retaining member 66 is attached. The retaining member attachment portion 64 is a portion projecting from the guyline fixing portion 63 in the axial direction of the specific coupling pin 60A on the side opposite to the head portion 61. As illustrated in FIGS. 11 and 13, the retaining member attachment portion 64 protrudes outward (the right side in FIGS. 11 and 13) in the width direction of the boom 3 from the third connector part 83 in a state where the specific coupling pin 60A is inserted into the pin holes of the first to third connector parts 81 to 83.

A through hole 65 penetrating the retaining member attachment portion 64 in a direction orthogonal to the axial direction of the specific coupling pin 60A is formed in the retaining member attachment portion 64. The retaining member 66 includes an insertion portion that is a portion to be inserted into the through hole 65 of the retaining member attachment portion 64, and an annular portion connected to one end of the insertion portion and having a shape surrounding an outer periphery of the retaining member attachment portion 64. As illustrated in FIGS. 11 and 13, in a state where the specific coupling pin 60A is inserted into the pin holes of the first to third connector parts 81 to 83, the insertion portion of the retaining member 66 is inserted into the through hole 65 of the retaining member attachment portion 64, and the annular portion of the retaining member 66 is arranged so as to surround the outer periphery of the retaining member attachment portion 64. Accordingly, the specific coupling pin 60A is fixed to the first connector part 81 and the second connector part 82. Further, the boom-side connection portion 70 of the strut guyline 7 is positioned onto the specific coupling pin 60A, and the boom-side connection portion 70 is prevented from coming off from the specific coupling pin 60A and falling off.

Note that the retaining member may include, for example, a nut (not illustrated), and in this case, the retaining member attachment portion 64 may have a shape like a bolt (male screw).

As illustrated in FIGS. 11 and 13, in the present embodiment, the boom-side connection portion 70 of the right strut guyline 7 is arranged at a position adjacent to the lower right connector 80 on the right side with respect to the lower right connector 80 (specific connector 80A), that is, on the outside in the width direction of the boom 3 with respect to the lower right connector 80. Further, although not illustrated, the boom-side connection portion 70 of the left strut guyline 7 is arranged at a position adjacent to the lower left connector 80 on the left side with respect to the lower left connector 80 (specific connector 80A), that is, on the outside in the width direction of the boom 3 with respect to the lower left connector 80. This enables the left and right boom-side connection portions 70 to be fixed to a position adjacent to the lower right connector 80 and a position adjacent to the lower left connector 80, respectively, without the left and right strut guylines 7 interfering with the intermediate boom member 3C of the boom 3.

Note that, as described above, each of the normal coupling pins is inserted into the pin holes 81H and 82H of the first connector part 81 and the second connector part 82, but it is not necessary to position the boom-side connection portion 70 of the strut guyline 7. Therefore, each of the normal coupling pins includes a head portion, a connector body coupling portion, and a retaining member attachment portion, similarly to the specific coupling pin 60A, but does not include the guyline fixing portion 63 of the specific coupling pin 60A. Therefore, in each of the normal coupling pins, the retaining member attachment portion protrudes in the axial direction of the normal coupling pin from the connector body coupling portion on the side opposite to the head portion.

In the crane 100 according to the present embodiment described above, the boom-side connection portion 70 of the strut guyline 7 is detachably attached to the guyline attachment portion 89 of the specific connector 80A arranged at the position corresponding to the lying lower portion P1 of the boom 3. Therefore, in the strut guyline connecting work and the strut guyline removal work, it is unnecessary for the worker to ascend to the lying upper portion P2 of the boom 3 and descend from the lying upper portion P2 of the boom 3 while the boom 3 and the jib 4 are arranged in the lying attitude. That is, the worker can perform the strut guyline connecting work and the strut guyline removal work in the vicinity of the lying lower portion P1 of the boom 3. Thus, the strut guyline connecting work and the strut guyline removal work are shortened as compared with the conventional art. In addition, it is not necessary to move the boom-side connection portion 70 to a high position corresponding to the lying upper portion P2 of the boom 3 using the auxiliary crane (not illustrated). Therefore, the crane 100 can improve the workability of the strut guyline connecting work and the strut guyline removal work.

In the present embodiment, the specific connector 80A includes the first connector part 81 connected to the end portion of the intermediate boom member 3B, the second connector part 82 connected to the end portion of the intermediate boom member 3C and detachably coupled to the first connector part 81, and the third connector part 83 including the guyline attachment portion 89 and detachably coupled to the connector body (the first connector part 81 and the second connector part 82). The third connector part 83 is configured as a member separate from the first connector part 81 and the second connector part 82. For example, by designing the size of the connector body arrangement space of the third connector part 83 to match the size of an existing connector member, the third connector part 83 can be attached to the existing connector member. In this case, the existing connector member includes the first connector part 81 and the second connector part 82.

In addition, in the crane 100 according to the present embodiment, for example, when it is changed from the crane specification, in which the jib 4 is attached to the boom 3 so that the angle of the jib 4 with respect to the boom 3 can be changed, to the fixed jib specification, it is sufficient if the third connector part 83 is coupled to the existing connector member using the specific coupling pin 60A in a state where the boom 3 is assembled. Therefore, it is not necessary to disassemble all the booms 3 at the time of specification change as described above.

In the present embodiment, the plurality of coupling pins includes the specific coupling pin 60A used for the specific connector 80A, and the first connector part 81, the second connector part 82, and the third connector part 83 are coupled to each other by the specific coupling pin 60A. That is, since the first connector part 81, the second connector part 82, and the third connector part 83 can be coupled by the single specific coupling pin 60A, the workability of the strut guyline connecting work and the strut guyline removal work can be further improved.

Further, in the present embodiment, since the specific coupling pin 60A (specific coupling pin) couples the first connector part 81, the second connector part 82, and the third connector part 83 of the specific connector 80A, and positions the boom-side connection portion 70 of the strut guyline 7, an increase in the number of components can be suppressed.

In the present embodiment, the guyline attachment portion 89 of the specific connector 80A is located on the outside (the right side in FIGS. 11 and 13) in the width direction of the boom 3 with respect to the first connector part 81 and the second connector part 82. Therefore, the boom-side connection portion 70 and the guyline body of the strut guyline 7 can be extended toward the strut 6 from the position on the outside in the width direction of the boom 3 with respect to the first connector part 81 and the second connector part 82, so that the strut guyline 7 can be easily prevented from interfering with the boom 3.

In the present embodiment, the strut 6 includes the strut body 6A including the posts 601 and 601 extending from the jib proximal end portion of the jib 4, and the link member 6B supported by the strut body 6A. In the link member 6B, the strut-side connection portion 74 of the right strut guyline 7 can be located on the outside (the right side) in the width direction of the boom 3 with respect to the right post 601, and the strut-side connection portion 74 of the left strut guyline 7 can be located on the outside (the left side) in the width direction of the boom 3 with respect to the left post 601. Therefore, it is easy to avoid the strut guyline 7 from interfering with the boom guyline 8.

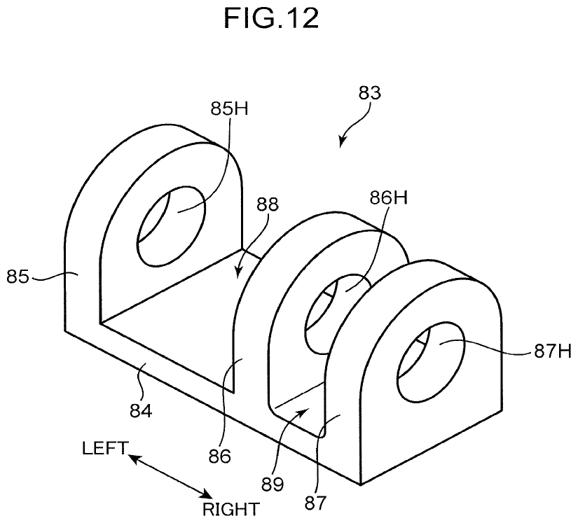

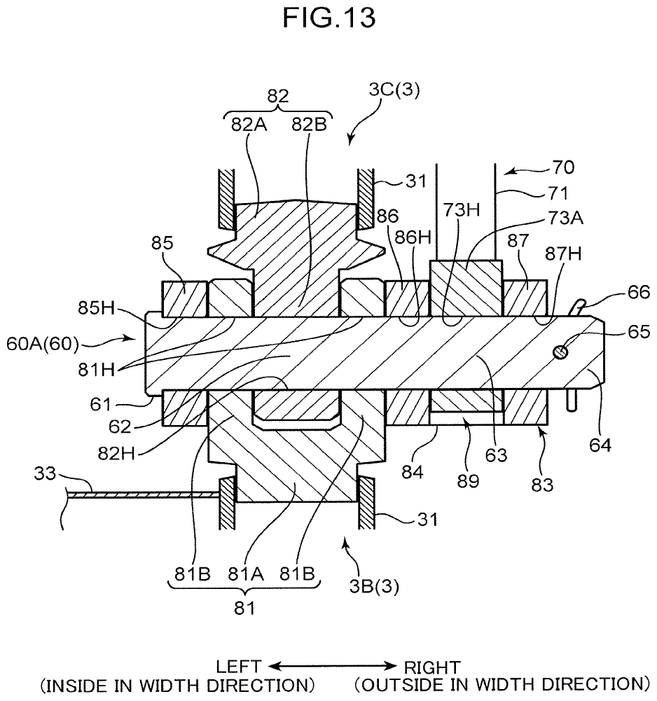

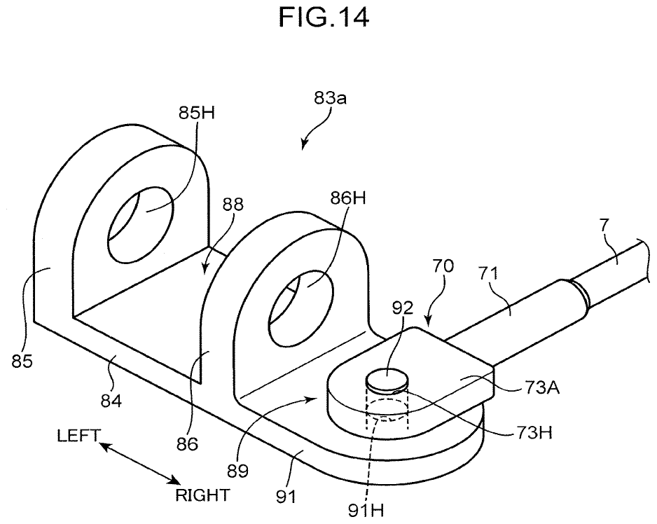

FIG. 14 is a perspective view illustrating a third connector part 83a which is a part of the specific connector 80A in the crane 100 according to Modification 1 of the present embodiment. In Modification 1, the structure of the guyline attachment portion 89 of the third connector part 83a is different from that of the third connector part 83 illustrated in FIG. 12. Other configurations of the crane 100 according to Modification 1 are similar to those of the crane 100 illustrated in FIGS. 1 to 13.

As illustrated in FIG. 14, the third connector part 83a includes the connector body attachment portion 88 for detachably attaching the connector body (the first connector part 81 and the second connector part 82), and the guyline attachment portion 89 for detachably attaching the boom-side connection portion 70 of the strut guyline 7.

The third connector part 83a includes a base portion 84, a plurality of wall portions, and a protruding piece 91. The base portion 84 is a portion extending along the left-right direction. The plurality of wall portions includes a wall portion 85 and a wall portion 86. The wall portion 85 and the wall portion 86 are portions corresponding to the inner wall portion 85 and the intermediate wall portion 86 of the third connector part 83 illustrated in FIG. 12. The wall portion 85 and the wall portion 86 are arranged with an interval in the left-right direction. The wall portion 85 is located on an inside (the left side in FIG. 14) in the width direction of the boom 3 with respect to the wall portion 86.

The base portion 84 has a plate-like shape extending in the left-right direction, and the wall portion 85 and the wall portion 86 each have a plate-like shape rising from the base portion 84 in a direction (upward in FIG. 14) orthogonal to the left-right direction. The base portion 84 connects an end portion of the wall portion 85 and an end portion of the wall portion 86. The connector body attachment portion 88 and the connector body arrangement space in the third connector part 83a illustrated in FIG. 14 are similar to the connector body attachment portion 88 and the connector body arrangement space in the third connector part 83 illustrated in FIG. 12. That is, the connector body attachment portion 88 includes the wall portion 85, a part of the wall portion 86 (the left side portion of the wall portion 86), and the base portion 84. The first connector part 81 and the second connector part 82 constituting the connector body are arranged in the connector body arrangement space which is a space defined by the wall portion 85, the wall portion 86, and the base portion 84.

The protruding piece 91 is a portion arranged so as to protrude outward (the right side in FIG. 14) in the width direction of the boom 3 from an outer end portion of the base portion 84. The outer end portion of the base portion 84 is an end portion of the base portion 84 located outside in the width direction of the boom 3. In the specific example illustrated in FIG. 14, the protruding piece 91 has a plate-like shape formed so as to protrude outward in the width direction from the outer end portion of the base portion 84 in an attitude substantially parallel to the base portion 84. The protruding piece 91 is located outside the base portion 84, the wall portion 85, and the wall portion 86 in the width direction.

In Modification 1, the guyline attachment portion 89 includes the protruding piece 91. The boom-side connection portion 70 of the strut guyline 7 is arranged so as to face a guyline arrangement surface which is a surface (an upper surface in FIG. 14) of the protruding piece 91. The protruding piece 91 includes a pin hole 91H penetrating the protruding piece 91 in the up-down direction.

The boom-side connection portion 70 of the strut guyline 7 includes a fixing portion 71 which is a portion to which one end portion of the guyline body is fixed, and an attached portion 73A which is a portion arranged so as to face the guyline arrangement surface of the third connector part 83 and attached to the guyline attachment portion 89. In Modification 1, the attached portion 73A has a shape corresponding to the guyline arrangement surface, specifically, a plate-like shape extending along the guyline arrangement surface. A pin hole 73H penetrating the attached portion 73A in the up-down direction is formed in the attached portion 73A.

In a state where the attached portion 73A of the boom-side connection portion 70 is arranged so as to face the guyline arrangement surface of the protruding piece 91 of the guyline attachment portion 89, the pin 92 is inserted into the pin hole 73H of the attached portion 73A and the pin hole 91H of the protruding piece 91. Accordingly, the boom-side connection portion 70 of the strut guyline 7 is detachably attached to the guyline attachment portion 89 of the third connector part 83.

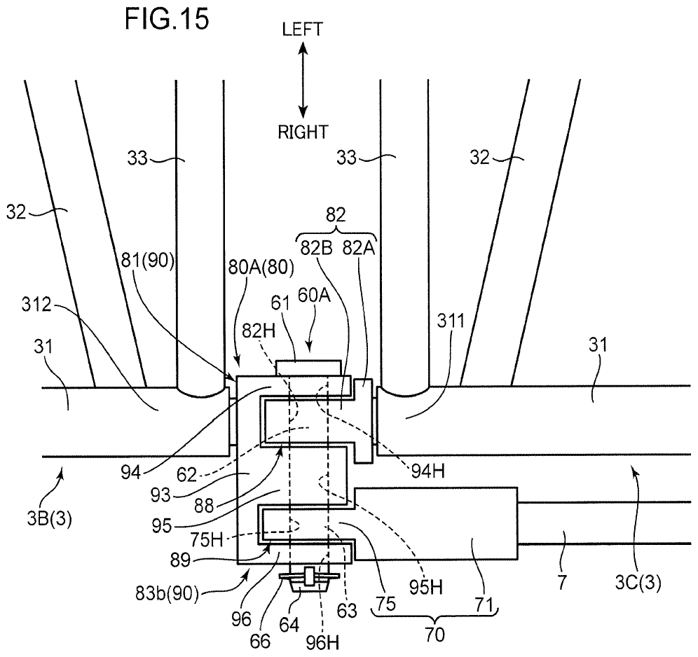

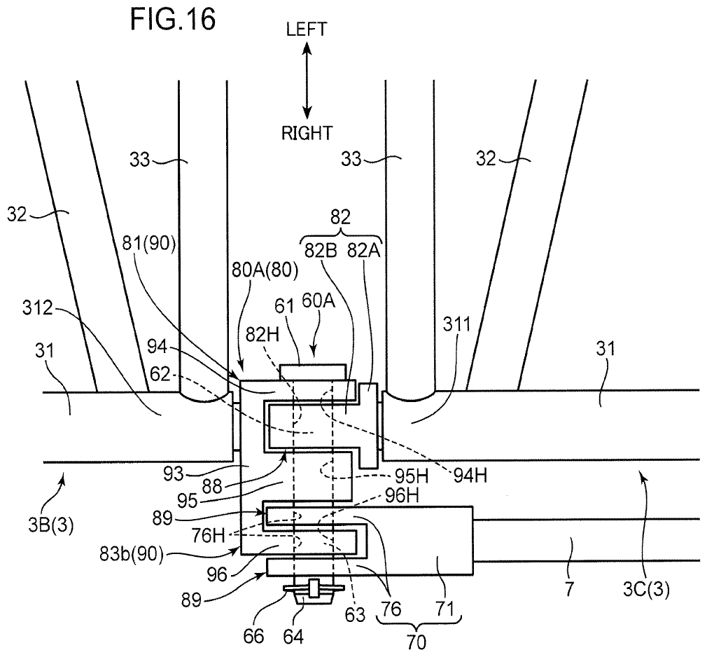

FIG. 15 is a perspective view illustrating a specific connector 80A in a crane 100 according to Modification 2 of the second embodiment. FIG. 16 is a perspective view illustrating a specific connector in a crane 100 according to Modification 3 of the second embodiment.

In each of the specific connectors 80A of the crane 100 according to the second embodiment illustrated in FIGS. 1 to 3 and FIGS. 11 to 13 and Modification 1 of the second embodiment illustrated in FIG. 14, the third connector part 83 is configured as a member separate from the first connector part 81 and the second connector part 82, but in each of the specific connectors 80A of the crane 100 according to Modification 2 illustrated in FIG. 15 and Modification 3 illustrated in FIG. 16, a third connector part 83b constitutes a single member together with a first connector part 81. Other configurations in Modification 2 and Modification 3 are similar to those of the embodiment illustrated in FIGS. 1 to 3 and FIGS. 11 to 13.

As illustrated in FIG. 15, the specific connector 80A includes a first connector part 81 connected to the end portion (main pipe distal end portion) of the main pipe 31 of the intermediate boom member 3B, a second connector part 82 connected to the end portion (main pipe proximal end portion) of the main pipe 31 of the intermediate boom member 3C and detachably coupled to the first connector part 81, and a third connector part 83b.

The third connector part 83b includes a guyline attachment portion 89. The third connector part 83b constitutes a single member together with the first connector part 81. In Modification 2, the first connector part 81 and the third connector part 83b may be manufactured by being integrally molded at the same time, or the first connector part 81 and the third connector part 83b may be integrated by a joining means such as welding after the first connector part 81 and the third connector part 83b are individually molded. Hereinafter, the first connector part 81 and the third connector part 83b are referred to as a connector composite 90.

The connector composite 90 includes an attachment portion 93 which is a portion attached to the main pipe distal end portion 312 of the main pipe 31 of the intermediate boom member 3B, and a plate-shaped inner protrusion 94, an intermediate protrusion 95, and an outer protrusion 96 each protruding from the attachment portion 93 in the longitudinal direction of the main pipe 31. The three protrusions 94, 95, and 96 are arranged with an interval in the left-right direction. Each of the three protrusions 94, 95, and 96 has, for example, a plate-like shape.

The attachment portion 93 has a shape extending in the left-right direction, and includes an inner portion that is a portion connecting an end portion of the inner protrusion 94 and an end portion of the intermediate protrusion 95, and an outer portion that is a portion connecting the end portion of the intermediate protrusion 95 and an end portion of the outer protrusion 96.

In the connector composite 90, the first connector part 81 includes the inner protrusion 94, a part of the intermediate protrusion 95 (a left side portion of the intermediate protrusion 95), and an inner portion of the attachment portion 93.

The third connector part 83b of the connector composite 90 includes a guyline attachment portion 89 which is a portion for detachably attaching the boom-side connection portion 70 of the strut guyline 7. The guyline attachment portion 89 includes a part of the intermediate protrusion 95 (a right side portion of the intermediate protrusion 95), the outer protrusion 96, and an outer portion of the attachment portion 93.

The second connector part 82 includes an attachment portion 82A which is a portion attached to the main pipe proximal end portion 311 of the main pipe 31 of the intermediate boom member 3C, and a plate-shaped protrusion 82B protruding from the attachment portion 82A in the longitudinal direction of the main pipe 31. The protrusion 82B of the second connector part 82 is arranged in a second connector arrangement space that is a space defined by the inner protrusion 94 of the connector composite 90, the intermediate protrusion 95, and the inner portion of the attachment portion 93. The protrusion 82B of the second connector part 82 includes a pin hole 82H penetrating the protrusion 82B in the left-right direction.

The boom-side connection portion 70 of the strut guyline 7 is arranged in a guyline arrangement space which is a space defined by the intermediate protrusion 95, the outer protrusion 96, and the outer portion of the attachment portion 93.

The boom-side connection portion 70 of the strut guyline 7 includes a fixing portion 71 which is a portion to which one end portion of the guyline body is fixed, and an attached portion 75 which is a portion arranged in the guyline arrangement space of the third connector part 83 and attached to the guyline attachment portion 89. The attached portion 75 has a shape corresponding to the guyline arrangement space. The attached portion 75 is formed with a pin hole 75H penetrating the attached portion 75 in the left-right direction.

In the connector composite 90, the inner protrusion 94 includes a pin hole 94H penetrating the inner protrusion 94 in the left-right direction, the intermediate protrusion 95 includes a pin hole 95H penetrating the intermediate protrusion 95 in the left-right direction, and the outer protrusion 96 includes a pin hole 96H penetrating the outer protrusion 96 in the left-right direction.

By inserting the specific coupling pin 60A into the pin holes 94H, 95H, 96H, 82H, and 75H, the connector composite 90 including the first connector part 81 and the third connector part 83b, the second connector part 82, and the boom-side connection portion 70 of the strut guyline 7 are coupled to each other.

In Modification 3 illustrated in FIG. 16, the shape of the boom-side connection portion 70 of the strut guyline 7 is different from the shape of the boom-side connection portion 70 in Modification 2 illustrated in FIG. 15, and the other configurations are similar to those of Modification 2 illustrated in FIG. 15.

As in Modification 2, the third connector part 83b of the connector composite 90 according to Modification 3 includes the guyline attachment portion 89 which is a portion for detachably attaching the boom-side connection portion 70 of the strut guyline 7. The guyline attachment portion 89 includes a part of the intermediate protrusion 95 (a right side portion of the intermediate protrusion 95), the outer protrusion 96, and an outer portion of the attachment portion 93.

As illustrated in FIG. 16, the boom-side connection portion 70 of the strut guyline 7 includes a fixing portion 71 which is a portion to which one end portion of the guyline body is fixed, and a pair of left and right attached portions 76 which are portions arranged in the guyline arrangement space of the third connector part 83b and attached to the guyline attachment portion 89. The pair of attached portions 76 is arranged with an interval in the left-right direction. Out of the pair of attached portions 76, the attached portion 76 on the inside in the width direction of the boom 3 (the left side in FIG. 16) has a shape corresponding to the guyline arrangement space. Out of the pair of attached portions 76, the attached portion 76 on the outside (the right side in FIG. 16) in the width direction of the boom 3 has a shape along an outer surface (the right side surface in FIG. 16) of the outer protrusion 96 of the connector composite 90. The inner attached portion 76 is arranged in the guyline arrangement space, and the outer attached portion 76 is arranged at a position adjacent to the outer protrusion 96 on the outside in the width direction with respect to the outer protrusion 96 of the connector composite 90.

Each of the pair of attached portions 76 is formed with a pin hole 76H penetrating the attached portion 76 in the left-right direction. By inserting the specific coupling pin 60A into the pin holes 94H, 95H, 96H, 82H, 76H, and 76H, the connector composite 90 including the first connector part 81 and the third connector part 83b, the second connector part 82, and the boom-side connection portion 70 of the strut guyline 7 are coupled to each other.

In these Modifications 2 and 3, since the third connector part 83b is not a member configured separately from both the first connector part 81 and the second connector part 82 but constitutes a single member together with the first connector part 81, it is not necessary to perform the work of fixing the third connector part 83b to at least one of the first connector part 81 and the second connector part 82 and the work of detaching the third connector part 83b from at least one of the first connector part 81 and the second connector part 82. Thus, the workability of the strut guyline connecting work and the strut guyline removal work can be further improved.

The present disclosure is not limited to the embodiments described above. The present disclosure includes, for example, the following modes.

### (A) Position of Boom-Side Connection Portion of Strut Guyline

In the above embodiment, the boom-side connection portion 70 of the strut guyline 7 is arranged at a position adjacent to the specific connector 80A on the outside in the width direction of the boom 3 with respect to the specific connector 80A, but may be arranged at a position adjacent to the specific connector 80A on the inside in the width direction of the boom 3 with respect to the specific connector 80A. Specifically, the boom-side connection portion 70 of the right strut guyline 7 may be arranged on the left side with respect to the lower right connector 80 (specific connector 80A), that is, on the inside in the width direction of the boom 3 with respect to the lower right connector 80 at a position adjacent to the lower right connector 80 in the left-right direction. In addition, the boom-side connection portion 70 of the left strut guyline 7 may be arranged on the right side with respect to the lower left connector 80 (specific connector 80A), that is, on the inside in the width direction of the boom 3 with respect to the lower left connector 80 at a position adjacent to the lower left connector 80 in the left-right direction. Similarly, in the crane 100 according to the modification, the boom-side connection portion 70 of the strut guyline 7 may be arranged at a position adjacent to the specific connector 80A on the inside in the width direction of the boom 3 with respect to the specific connector 80A.

### (B) Specific Connector

In Modification 2 and Modification 3, the third connector part constitutes a connector composite which is a single member together with the first connector part, but may constitute a single member (connector composite) together with the second connector part.

### (C) Strut

In the above embodiment, the width in the left-right direction at the distal end portion of the strut body 6A is smaller than the interval between the boom-side connection portion 70 of the right strut guyline 7 and the boom-side connection portion 70 of the left strut guyline 7, but the width in the left-right direction at the distal end portion of the strut body 6A may be substantially the same as the distance between the left and right boom-side connection portions 70. In this case, the link member 6B of the strut 6 can be omitted.

### (D) Crane Specifications

In the above embodiment, the machine body is a self-travelling crane including the lower travelling body, but the machine body may be, for example, fixed to the ground and incapable of self-travelling. In addition, the crane 100 according to the present embodiment is what is called a fixed jib specification crane, but may be a crane capable of changing the angle of the jib 4 with respect to the boom 3.

### (E) Support Member

In the above embodiment, the support member is constituted of the mast 5, but the support member may be, for example, a gantry. The gantry is supported by the upper slewing body 2 behind the boom 3, and is connected to the distal end portion of the boom 3 via, for example, a boom guyline.

### (F) Specific Coupling Pin

In the above embodiment, the insertion direction of the specific coupling pin 60A is a direction from the inside to the outside in the width direction of the boom 3 with respect to the specific connector 80A, but may be a direction opposite to that of the above embodiment.

As described above, according to the present disclosure, there is provided a crane capable of improving the workability of the strut guyline connecting work and the strut guyline removal work.

A crane to be provided includes a machine body, a boom supported on the machine body in a raisable and lowerable manner, the boom including a first boom member and a second boom member arranged in a line in a longitudinal direction of the boom, a plurality of connectors coupling the first boom member and the second boom member, and a plurality of coupling pins respectively inserted into pin holes of the plurality of connectors, a jib that is supported by the boom and includes a proximal end portion attached to a distal end portion of the boom, a strut supported by the distal end portion of the boom or the proximal end portion of the jib, and a strut guyline that is a guyline stretched between a lying lower portion, which is a portion located at a lower portion of the boom in a state where the boom and the jib are arranged in a lying attitude, and the strut, the strut guyline including a boom-side connection portion that is an end portion connected to the lying lower portion of the boom, in which the plurality of connectors includes a specific connector that is a connector arranged at a position corresponding to the lying lower portion, the plurality of coupling pins includes a specific coupling pin used in the specific connector, and the specific coupling pin or the specific connector includes a guyline attachment portion which is a portion to which the boom-side connection portion of the strut guyline is detachably attached.

In this crane, the boom-side connection portion of the strut guyline is attached to the specific coupling pin or the specific connector arranged at the position corresponding to the lying lower portion located at the lower portion of the boom in a state where the boom and the jib are arranged in the lying attitude. Therefore, in the strut guyline connecting work and the strut guyline removal work, it is unnecessary for the worker to ascend to the lying upper portion of the boom and descend from the lying upper portion of the boom while the boom and the jib are arranged in the lying attitude. That is, the worker can perform the strut guyline connecting work and the strut guyline removal work in the vicinity of the lying lower portion of the boom. Thus, the strut guyline connecting work and the strut guyline removal work are shortened as compared with the conventional art. In addition, it is not necessary to move the boom-side connection portion to a high position corresponding to the lying upper portion of the boom by using an auxiliary crane. Therefore, the crane can improve the workability of the strut guyline connecting work and the strut guyline removal work.

The specific coupling pin may be configured to be inserted into the pin hole of the specific connector, and may include the guyline attachment portion.

In this case, the boom-side connection portion of the strut guyline is preferably arranged at a position adjacent to the specific connector on an outside in a width direction of the boom with respect to the specific connector. In this configuration, the boom-side connection portion of the strut guyline is arranged at the position on the outside in the width direction of the boom with respect to the specific connector, and the strut guyline can be extended from the position toward the strut, so that the strut guyline can be easily prevented from interfering with the boom.

It is preferable that the crane further includes a support member supported by the machine body, and a boom guyline extending from the distal end portion of the boom toward the support member, in which the strut guyline includes a strut-side connection portion which is an end portion on a side opposite to the boom-side connection portion and is connected to the strut, and the strut includes a strut body including a post extending from the distal end portion of the boom or the proximal end portion of the jib, and a link member supported by the strut body, the link member being capable of positioning the strut-side connection portion outside the post in the width direction of the boom. With this configuration, it is easy to avoid the strut guyline from interfering with the boom guyline.

The specific connector may include the guyline attachment portion.

In this case, the specific connector preferably includes a first connector part connected to an end portion of the first boom member, a second connector part connected to an end portion of the second boom member and detachably coupled to the first connector part, and a third connector part including the guyline attachment portion and detachably coupled to at least one of the first connector part and the second connector part. In this configuration, the third connector part is configured as a member separate from the first connector part and the second connector part, and thus, for example, the third connector part according to the present disclosure can be attached to an existing connector member including the first connector part and the second connector part.

Preferably, the first connector part, the second connector part, and the third connector part are configured to be coupled to each other by the specific coupling pin. In this configuration, since the first connector part, the second connector part, and the third connector part can be coupled by the single specific coupling pin, the workability of the strut guyline connecting work and the strut guyline removal work can be further improved.

Preferably, the specific connector includes a first connector part connected to an end portion of the first boom member, a second connector part connected to an end portion of the second boom member and detachably coupled to the first connector part, and a third connector part including the guyline attachment portion and constituting a single member together with one of the first connector part and the second connector part. In this configuration, the third connector part constitutes a single member together with one of the first connector part and the second connector part instead of a member configured separately from both the first connector part and the second connector part, and thus a work for fixing the third connector part to at least one of the first connector part and the second connector part and a work for detaching the third connector part from at least one of the first connector part and the second connector part are unnecessary. Thus, the workability of the strut guyline connecting work and the strut guyline removal work can be further improved.

Preferably, the guyline attachment portion is located on an outside in the width direction of the boom with respect to the first connector part and the second connector part. In this configuration, the strut guyline can be extended toward the strut from a position outside in the width direction of the boom with respect to the first connector part and the second connector part, so that the strut guyline can be easily prevented from interfering with the boom.

It is preferable that the crane further includes a support member supported by the machine body, and a boom guyline extending from the distal end portion of the boom toward the support member, in which the strut guyline includes a strut-side connection portion which is an end portion on a side opposite to the boom-side connection portion and is connected to the strut, and the strut includes a strut body including a post extending from the distal end portion of the boom or the proximal end portion of the jib, and a link member supported by the strut body, the link member being capable of positioning the strut-side connection portion outside the post in the width direction of the boom. With this configuration, it is easy to avoid the strut guyline from interfering with the boom guyline.

1. A crane comprising:
a machine body;
a boom supported on the machine body in a raisable and lowerable manner, the boom including a first boom member and a second boom member arranged in a line in a longitudinal direction of the boom, a plurality of connectors coupling the first boom member and the second boom member, and a plurality of coupling pins respectively inserted into pin holes of the plurality of connectors;
a jib that is supported by the boom and includes a proximal end portion attached to a distal end portion of the boom;
a strut supported by the distal end portion of the boom or the proximal end portion of the jib; and
a strut guyline that is a guyline stretched between a lying lower portion, which is a portion located at a lower portion of the boom in a state where the boom and the jib are arranged in a lying attitude, and the strut, the strut guyline including a boom-side connection portion that is an end portion connected to the lying lower portion of the boom,
wherein the plurality of connectors includes a specific connector that is a connector arranged at a position corresponding to the lying lower portion,
the plurality of coupling pins includes a specific coupling pin used in the specific connector, and
the specific coupling pin or the specific connector includes a guyline attachment portion which is a portion to which the boom-side connection portion of the strut guyline is detachably attached.

2. The crane according to claim 1, wherein the specific coupling pin is configured to be inserted into the pin hole of the specific connector, and includes the guyline attachment portion.

3. The crane according to claim 2, wherein the boom-side connection portion of the strut guyline is arranged at a position adjacent to the specific connector on an outside in a width direction of the boom with respect to the specific connector.

4. The crane according to claim 2, further comprising:
a support member supported by the machine body; and
a boom guyline extending from the distal end portion of the boom toward the support member,
wherein the strut guyline includes a strut-side connection portion which is an end portion on a side opposite to the boom-side connection portion and is connected to the strut, and
the strut includes
a strut body including a post extending from the distal end portion of the boom or the proximal end portion of the jib, and
a link member supported by the strut body, the link member being capable of positioning the strut-side connection portion outside the post in the width direction of the boom.

5. The crane according to claim 1, wherein the specific connector includes the guyline attachment portion.

6. The crane according to claim 5, wherein
the specific connector includes
a first connector part connected to an end portion of the first boom member,
a second connector part connected to an end portion of the second boom member and detachably coupled to the first connector part, and
a third connector part including the guyline attachment portion and detachably coupled to at least one of the first connector part and the second connector part.

7. The crane according to claim 6, wherein the first connector part, the second connector part, and the third connector part are configured to be coupled to each other by the specific coupling pin.

8. The crane according to claim 5, wherein
the specific connector includes
a first connector part connected to an end portion of the first boom member,
a second connector part connected to an end portion of the second boom member and detachably coupled to the first connector part, and
a third connector part including the guyline attachment portion and constituting a single member together with one of the first connector part and the second connector part.

9. The crane according to claim 6, wherein the guyline attachment portion is located on an outside in the width direction of the boom with respect to the first connector part and the second connector part.

10. The crane according to claim 5, further comprising:
a support member supported by the machine body; and
a boom guyline extending from the distal end portion of the boom toward the support member,
wherein the strut guyline includes a strut-side connection portion which is an end portion on a side opposite to the boom-side connection portion and is connected to the strut, and
the strut includes
a strut body including a post extending from the distal end portion of the boom or the proximal end portion of the jib, and
a link member supported by the strut body, the link member being capable of positioning the strut-side connection portion outside the post in the width direction of the boom.
